(19) United States
(12) Patent Application Publication
(10) Pub. No.: US 2025/0071592 A1
(43) Pub. Date: Feb. 27, 2025

(54) REPORTING REFERENCE SIGNAL MEASUREMENTS FOR PREDICTIVE BEAM MANAGEMENT

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 18/842,538

(22) PCT Filed: May 6, 2022
(86) PCT No.: PCT/CN2022/091084

§ 371 Date: Aug. 29, 2024

(51) Int. Cl. H04W 24/10

(52) U.S. Cl. CPC H04W 24/10

(57) ABSTRACT

Wireless communications systems, apparatuses, and methods are provided. A method of wireless communication performed by a user equipment (UE) may include receiving, from a network unit, a channel state information (CSI) report configuration, receiving, from the network unit, a plurality of reference signals, and transmitting, to the network unit based on the CSI report configuration, at least one CSI report, the at least one CSI report indicating one or more first reference signals of the plurality of reference signals satisfying a first threshold and one or more second reference signals of the plurality of reference signals satisfying a second threshold, wherein the second threshold is different from the first threshold.

### TECHNICAL FIELD

This application relates to wireless communication systems, and more particularly, to reporting reference signal measurements for predictive beam management.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment (UE) may include receiving, from a network unit, a channel state information (CSI) report configuration; receiving, from the network unit, a plurality of reference signals; and transmitting, to the network unit based on the CSI report configuration, at least one CSI report, the at least one CSI report indicating one or more first reference signals of the plurality of reference signals satisfying a first threshold and one or more second reference signals of the plurality of reference signals satisfying a second threshold, wherein the second threshold is different from the first threshold.

In an additional aspect of the disclosure, a method of wireless communication performed by a network unit may include transmitting, to a user equipment (UE), a channel state information (CSI) report configuration; transmitting, to the UE, a plurality of reference signals; and receiving, from the UE, at least one CSI report based on the CSI report configuration, the at least one CSI report indicating one or more first reference signals of the plurality of reference signals satisfying a first threshold and one or more second reference signals of the plurality of reference signals satisfying a second threshold, wherein the second threshold is different from the first threshold.

In an additional aspect of the disclosure, a user equipment (UE) may include a memory; a transceiver; and at least one processor coupled to the memory and the transceiver, wherein the UE is configured to receive, from a network unit, a channel state information (CSI) report configuration; receive, from the network unit, a plurality of reference signals; and transmit, to the network unit based on the CSI report configuration, at least one CSI report, the at least one CSI report indicating one or more first reference signals of the plurality of reference signals satisfying a first threshold; and one or more second reference signals of the plurality of reference signals satisfying a second threshold, wherein the second threshold is different from the first threshold.

In an additional aspect of the disclosure, a network unit may include a memory; a transceiver; and at least one processor coupled to the memory and the transceiver, wherein the network unit is configured transmit, to a user equipment (UE), a channel state information (CSI) report configuration; transmit, to the UE, a plurality of reference signals; and receive, from the UE, at least one CSI report based on the CSI report configuration, the at least one CSI report indicating one or more first reference signals of the plurality of reference signals satisfying a first threshold and one or more second reference signals of the plurality of reference signals satisfying a second threshold, wherein the second threshold is different from the first threshold.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates an example of reference signal thresholds according to some aspects of the present disclosure.

FIGS. 4A and 4B illustrate an example of reference signal thresholds according to some aspects of the present disclosure.

FIG. 5 illustrates an example of beam groups according to some aspects of the present disclosure.

FIG. 6 illustrates an example of CSI reporting periods according to some aspects of the present disclosure.

FIG. 7 illustrates an example of differential CSI reporting according to some aspects of the present disclosure.

FIG. 8 is a signaling diagram of a wireless communication method according to some aspects of the present disclosure.

FIG. 9 is a block diagram of an exemplary user equipment (UE) according to some aspects of the present disclosure.

FIG. 10 is a block diagram of an exemplary network unit according to some aspects of the present disclosure.

FIG. 11 is a flow diagram of a communication method according to some aspects of the present disclosure.

FIG. 12 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜ 10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannels in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

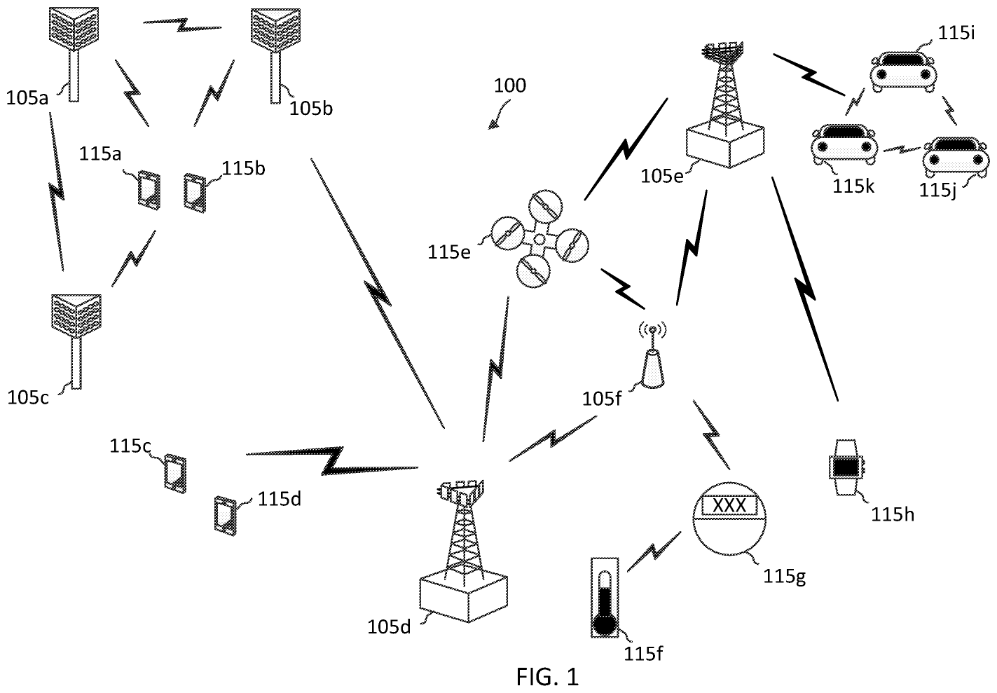

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115a may receive, from the BS 105a, a channel state information (CSI) report configuration. The UE 115a may receive, from the BS 105a, a plurality of reference signals. The UE 115a may transmit, to the BS 105a based on the CSI report configuration, at least one CSI report, the at least one CSI report indicating one or more first reference signals of the plurality of reference signals satisfying a first threshold and one or more second reference signals of the plurality of reference signals satisfying a second threshold. The second threshold may be different from the first threshold.

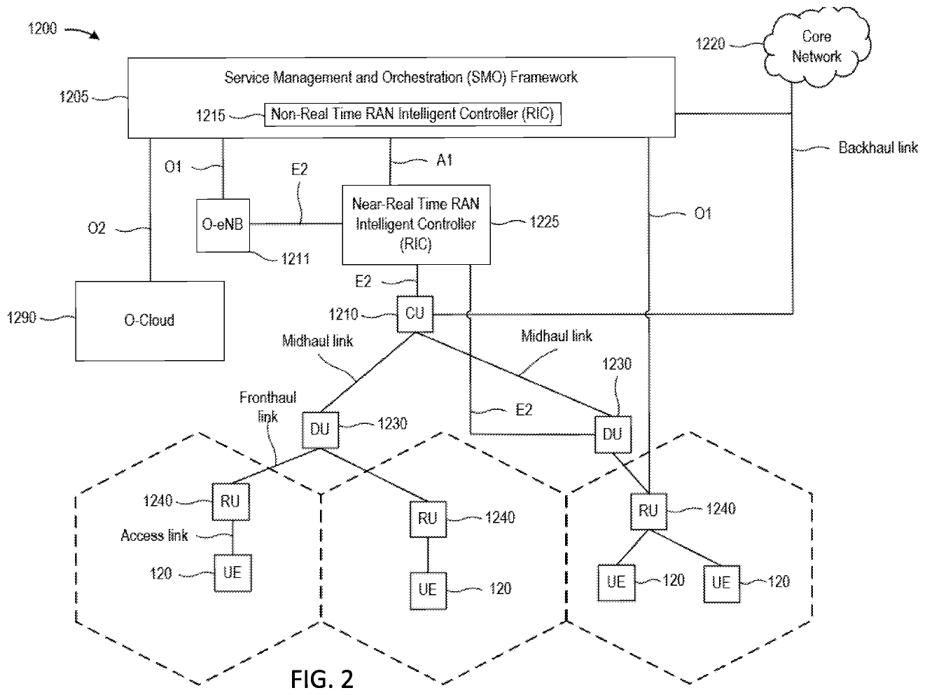

FIG. 2 shows a diagram illustrating an example disaggregated base station 1200 architecture. The disaggregated base station 1200 architecture may include one or more central units (CUs) 1210 that can communicate directly with a core network 1220 via a backhaul link, or indirectly with the core network 1220 through one or more disaggregated base station units (such as a Near-Real Time (Near-RT) RAN Intelligent Controller (RIC) 1225 via an E2 link, or a Non-Real Time (Non-RT) RIC 1215 associated with a Service Management and Orchestration (SMO) Framework 1205, or both). A CU 1210 may communicate with one or more distributed units (DUs) 1230 via respective midhaul links, such as an F1 interface. The DUs 1230 may communicate with one or more radio units (RUs) 1240 via respective fronthaul links. The RUs 1240 may communicate with respective UEs 120 via one or more radio frequency (RF) access links. In some implementations, the UE 120 may be simultaneously served by multiple RUs 1240.

Each of the units, i.e., the CUS 1210, the DUs 1230, the RUs 1240, as well as the Near-RT RICs 1225, the Non-RT RICs 1215 and the SMO Framework 1205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1210. The CU 1210 may be configured to handle user plane functionality (i.e., Central Unit-User Plane (CU-UP)), control plane functionality (i.e., Central Unit-Control Plane (CU-CP)), or a combination thereof. In some implementations, the CU 1210 can be logically split into one or more CU-UP units and one or more CU-CP units. The CU-UP unit can communicate bidirectionally with the CU-CP unit via an interface, such as the E1 interface when implemented in an O-RAN configuration. The CU 1210 can be implemented to communicate with the DU 1230, as necessary, for network control and signaling.

The DU 1230 may correspond to a logical unit that includes one or more base station functions to control the operation of one or more RUs 1240. In some aspects, the DU 1230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1230 may further host one or more low PHY layers. Each layer (or module) can be implemented with an interface configured to communicate signals with other layers (and modules) hosted by the DU 1230, or with the control functions hosted by the CU 1210.

Lower-layer functionality can be implemented by one or more RUs 1240. In some deployments, an RU 1240, controlled by a DU 1230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1240 can be implemented to handle over the air (OTA) communication with one or more UEs 120. In some implementations, real-time and non-real-time aspects of control and user plane communication with the RU(s) 1240 can be controlled by the corresponding DU 1230. In some scenarios, this configuration can enable the DU(s) 1230 and the CU 1210 to be implemented in a cloud-based RAN architecture, such as a vRAN architecture.

The SMO Framework 1205 may be configured to support RAN deployment and provisioning of non-virtualized and virtualized network elements. For non-virtualized network elements, the SMO Framework 1205 may be configured to support the deployment of dedicated physical resources for RAN coverage requirements which may be managed via an operations and maintenance interface (such as an O1 interface). For virtualized network elements, the SMO Framework 1205 may be configured to interact with a cloud computing platform (such as an open cloud (O-Cloud) 1290) to perform network element life cycle management (such as to instantiate virtualized network elements) via a cloud computing platform interface (such as an O2 interface). Such virtualized network elements can include, but are not limited to, CUs 1210, DUs 1230, RUs 1240 and Near-RT RICs 1225. In some implementations, the SMO Framework 1205 can communicate with a hardware aspect of a 4G RAN, such as an open eNB (O-eNB) 1211, via an O1 interface. Additionally, in some implementations, the SMO Framework 1205 can communicate directly with one or more RUs 1240 via an O1 interface. The SMO Framework 1205 also may include a Non-RT RIC 1215 configured to support functionality of the SMO Framework 1205.

The Non-RT RIC 1215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1225. The Non-RT RIC 1215 may be coupled to or communicate with (such as via an A1 interface) the Near-RT RIC 1225. The Near-RT RIC 1225 may be configured to include a logical function that enables near-real-time control and optimization of RAN elements and resources via data collection and actions over an interface (such as via an E2 interface) connecting one or more CUs 1210, one or more DUs 1230, or both, as well as an O-eNB, with the Near-RT RIC 1225.

In some implementations, to generate AI/ML models to be deployed in the Near-RT RIC 1225, the Non-RT RIC 1215 may receive parameters or external enrichment information from external servers. Such information may be utilized by the Near-RT RIC 1225 and may be received at the SMO Framework 1205 or the Non-RT RIC 1215 from non-network data sources or from network functions. In some examples, the Non-RT RIC 1215 or the Near-RT RIC 1225 may be configured to tune RAN behavior or performance. For example, the Non-RT RIC 1215 may monitor long-term trends and patterns for performance and employ AI/ML models to perform corrective actions through the SMO Framework 1205 (such as reconfiguration via 01) or via creation of RAN management policies (such as A1 policies).

In some aspects, a method of wireless communication may be performed by the UE 120. The method may include monitoring a first set of physical downlink control channel (PDCCH) candidate resources for a PDCCH communication from the RU 1240, receiving, from the RU 1240, a plurality of demodulation reference signals (DMRSs) and decoding, based on a metric associated with the plurality of demodulation reference signals (DMRSs) satisfying a threshold, the PDCCH communication.

In some aspects, a first UE 120 may transmit a configuration to a second UE 120 indicating at least one of a length associated with a sidelink synchronization signal block (S-SSB) burst, a quasi-colocation (QCL) index associated with the S-SSB burst, or a first QCL order associated with the S-SSB burst. In some aspects, the first UE 120 may transmit the S-SSB burst to the second UE 120 based on the at least one of the length associated with the S-SSB burst, the QCL index associated with the S-SSB burst, or the first QCL order associated with the S-SSB burst.

In some aspects, a first UE 120 may transmit to the RU 1240, an indication associated with channel occupancy time (COT) sharing on sidelink communication. The first UE 120 may receive, from the RU 1240, a COT indicator, wherein the COT indicator indicates to the first UE 120 to initiate a COT on sidelink communication based on the indication associated with the COT sharing or the COT indicator indicates to the first UE 120 to share the COT on sidelink communication based on the indication associated with the COT sharing on sidelink communication. The first UE 120 may transmit, to a second UE 120, a communication during the COT on sidelink communication.

In some aspects, the UE 120 may receive, from the RU 1240, a channel state information (CSI) report configuration. The UE 120 may receive, from the RU 1240, a plurality of reference signals. The UE 120 may transmit, to the RU 1240 based on the CSI report configuration, at least one CSI report, the at least one CSI report indicating one or more first reference signals of the plurality of reference signals satisfying a first threshold and one or more second reference signals of the plurality of reference signals satisfying a second threshold. The second threshold may be different from the first threshold.

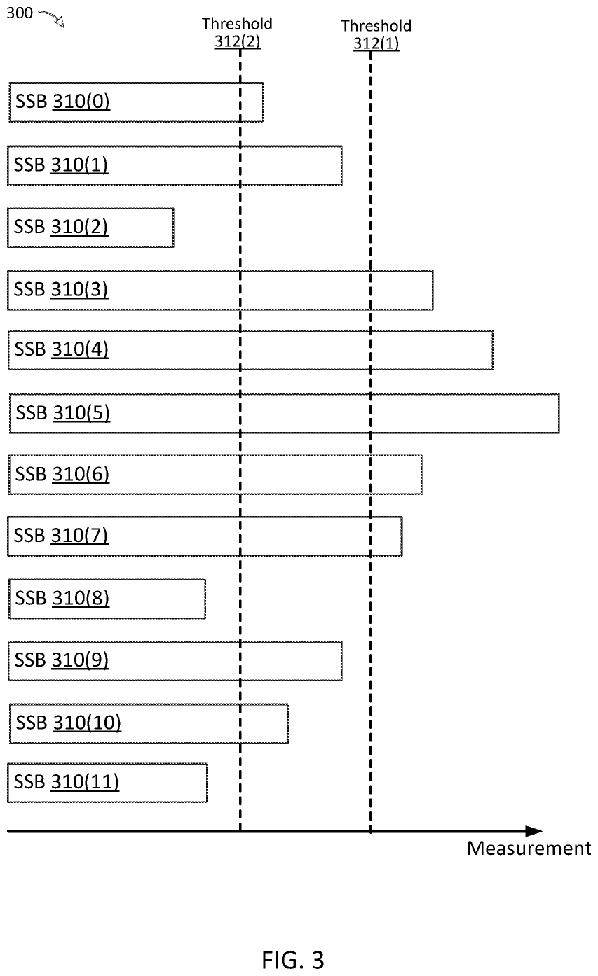

FIG. 3 illustrates an example of reference signal thresholds 300 according to some aspects of the present disclosure. The reference signal thresholds 300 may be implemented by aspects of the wireless communications network 100 and/or the wireless communications network 1200. For example, the reference signal thresholds 300 may be implemented for communications by one or more UEs, (e.g., UE 115, UE 120, or UE 900) such as described by the wireless communications network 100 and/or 1200. In FIG. 3, the x-axis represents a reference signal measurement in some arbitrary units.

In some aspects, a UE (e.g., the UE 115, the UE 120, or the UE 900) may receive a channel state information (CSI) report configuration from a network unit (e.g., the BS 105, the RU 1240, the DU 1230, the CU 1210, and/or the network unit 1000). In this regard, the UE may receive the CSI report configuration from the network unit via an aperiodic triggering state configuration downlink control information (DCI), DCI, a radio resource control (RRC) message, a semi-persistent activation state configuration via a medium access control control element (MAC-CE), a MAC-CE, a PDCCH message, a PDSCH message, or other suitable communication.

The CSI report configuration may indicate one or more threshold values. For example, the CSI report configuration may indicate a first threshold 312(1), a second threshold 312(2), a third threshold, etc. associated with the reference signal(s) SSB 310. The UE may receive a plurality of reference signals from the network unit. The plurality of reference signals may include channel state information reference signals (CSI-RSs), synchronization signal blocks (SSBs) 310, and/or other reference signals. In some instances, the network unit may broadcast the PSS, the SSS, and/or the MIB in the form of synchronization signal blocks (SSBs) 310 over a physical broadcast channel (PBCH). The reference signals may include zero power channel state information reference signals (ZP-CSI-RSs), non-zero power channel state information reference signals (NZP-CSI-RSs), and/or SSBs 310. Each of the reference signals may be identified by a channel measurement resource identifier (CMR-ID). The CSI-RS may be a reference signal used in the downlink direction for the purpose of channel sounding and may be used by the UE to measure one or more characteristics of the radio channel.

In some aspects, the CSI report(s) may indicate the first reference signal(s) of the plurality of reference signals satisfying a first threshold 312(1). In this regard, satisfying the first threshold 312(1) may include an RSRP of the first reference signal(s) being greater than (or greater than or equal to) the first threshold 312(1) and/or an SINR of the first reference signal(s) being greater than (or greater than or equal to) the first threshold 312(1). The CSI report configuration may indicate a number of the strongest reference signals greater than threshold 312(1) that should be reported. For example, the CSI report configuration may indicate two of the strongest reference signals greater than threshold 312(1) should be reported. In this case, the UE will report SSB 310(4) and SSB 310(5) as the strongest reference signals.

In some aspects, the CSI report(s) may indicate the second reference signal(s) of the plurality of reference signals satisfying a second threshold 312(2). In this regard, satisfying the second threshold 312(2) may include an RSRP of the second reference signal(s) being greater than (or greater than or equal to) the second threshold 312(2) and less than (or less than or equal to) the first threshold 312(1). Additionally or alternatively, satisfying the second threshold 312(2) may include an SINR of the second reference signal(s) being greater than (or greater than or equal to) the second threshold 312(2) and less than (or less than or equal to) the first threshold 312(1). In some aspects, the CSI report(s) may indicate the additional reference signal(s) that satisfy a third threshold, a fourth threshold, and/or other thresholds. The CSI report configuration may indicate a number of the reference signals satisfying the second threshold 312(2) that should be reported. For example, the CSI report configuration may indicate four of the reference signals satisfying the second threshold 312(2) should be reported. In this case, the UE will report SSB 310(0), SSB 310(1), SSB 310(9), and SSB 310(10) as satisfying the second threshold 312(2).

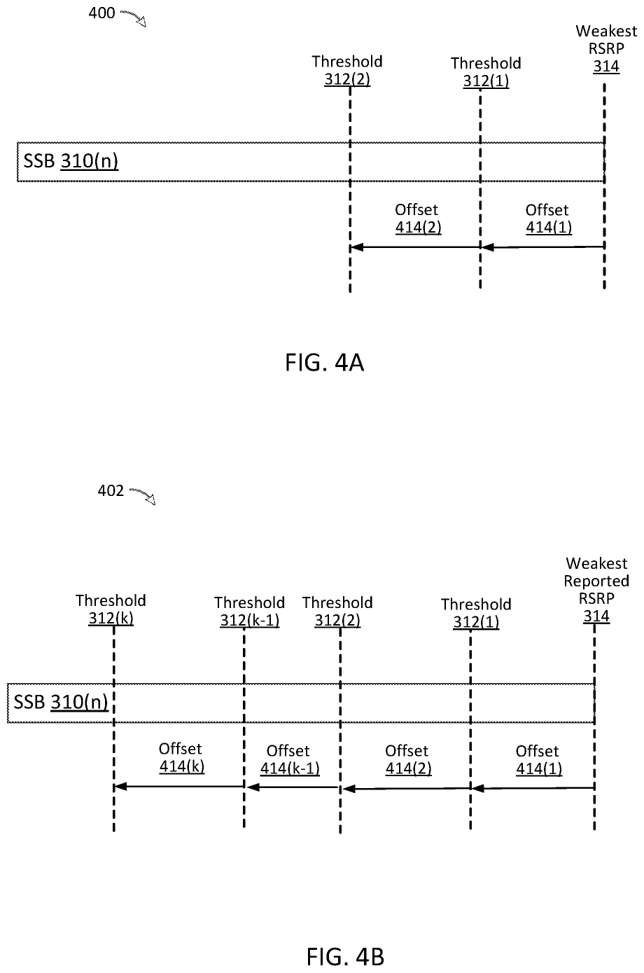

FIG. 4A illustrates an example of reference signal thresholds 400 according to some aspects of the present disclosure. The reference signal thresholds 400 may be implemented by aspects of the wireless communications network 100 and/or the wireless communications network 1200. For example, the reference signal thresholds 400 may be implemented for communications by one or more UEs, (e.g., UE 115, UE 120, or UE 900) such as described by the wireless communications network 100 and/or 1200.

Measurements of the reference signal(s) may be compared to the thresholds to determine if each the reference signal(s) satisfies a threshold. In some aspects, the thresholds may be represented as absolute values and/or relative values. For example, the thresholds may be represented as absolute values (e.g., dBm values). Additionally or alternatively, the thresholds may be represented as values (e.g., dB values) relative to other thresholds (e.g., relative to an absolute value and/or relative to another relative value). In some aspects, a first threshold 312(1) may be based on a first offset 414(1) from a measurement associated with a reference signal SSB 310(n) of the first reference signals satisfying the first threshold. For example, the measurement associated with a reference signal SSB 310(n) of the first reference signals satisfying the first threshold 312(1) may include the weakest RSRP 314 measurement (e.g., the lowest RSRP) associated with the first reference signals (e.g., a set of first reference signals SSB 310(4) and SSB 310(5)) that are the strongest of the first reference signals greater than the first threshold 312(1). The CSI report configuration may indicate the number of reference signals (e.g., two reference signals) in the set of first reference signals. The CSI report(s) may include CMR-IDs of the set of first reference signals that are the strongest of the first reference signals greater than the first threshold 312(1). The first threshold 312(1) may be determined relative to the RSRP 314 of the weakest reference signal (e.g., SSB 310(n)) among the set of first reference signals that are the strongest of the first reference signals. For example, the first threshold 312(1) may be set based on an offset 414(1) that is a number of decibels lower (e.g., −10 dB lower, −20 dB lower, etc.) than the RSRP 314 of the weakest reference signal among the set of first reference signals that are the strongest of the first reference signals. The second threshold 312(2) may be set based on an offset 414(2) that is a number of decibels lower (e.g., −10 dB lower, −20 dB lower, etc.) than the first threshold 312(1).

FIG. 4B illustrates an example of reference signal thresholds 402 according to some aspects of the present disclosure. The reference signal thresholds 402 may be implemented by aspects of the wireless communications network 100 and/or the wireless communications network 1200. For example, the reference signal thresholds 402 may be implemented for communications by one or more UEs, (e.g., UE 115, UE 120, or UE 900) such as described by the wireless communications network 100 and/or 1200.

In some aspects, the CSI report configuration may indicate any number of thresholds. The CSI report(s) may include CMR-IDs of the set of first reference signals that are the strongest of the first reference signals greater than the first threshold 312(1). The first threshold 312(1) may be determined relative to the RSRP 314 of the weakest reference signal (e.g., SSB 310(n)) among the set of first reference signals that are the strongest of the first reference signals. For example, the first threshold 312(1) may be set based on an offset 414(1) that is a number of decibels lower (e.g., −10 dB lower, −20 dB lower, etc.) than the RSRP 314 of the weakest reference signal among the set of first reference signals that are the strongest of the first reference signals. The second threshold 312(2) may be set based on an offset 414(2) that is a number of decibels lower (e.g., −10 dB lower, −20 dB lower, etc.) than the first threshold 312(1). In some aspects, another threshold 312(k−1) may be set based on an offset 414(k−1) that is a number of decibels lower (e.g., −10 dB lower, −20 dB lower, etc.) than the second threshold 312(2). Another threshold 312(k) may be set based on an offset 414(k) that is a number of decibels lower (e.g., −10 dB lower, −20 dB lower, etc.) than the second threshold 312(k−1). In some aspects, a fourth threshold, a fifth threshold, etc. may be set in a similar relative fashion.

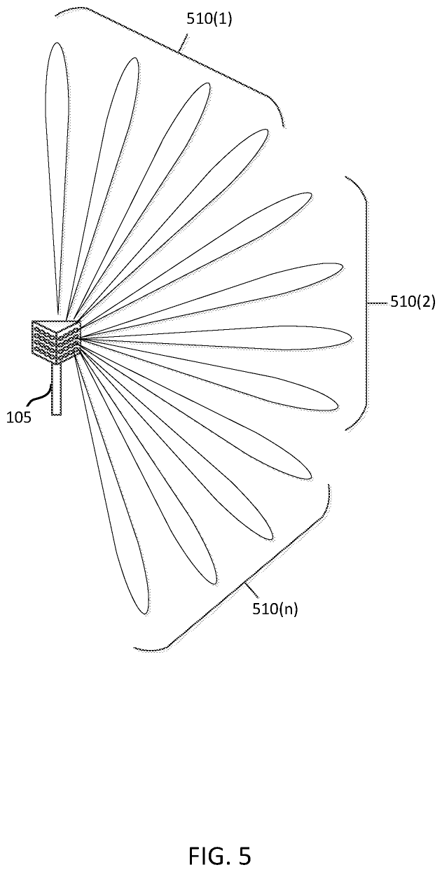

FIG. 5 illustrates an example of an example of beam groups according to some aspects of the present disclosure. The beam groups may be implemented by aspects of the wireless communications network 100 and/or the wireless communications network 1200. For example, the beam groups may be implemented for communications by one or more network units (e.g., the BS 105, the RU 1240, the DU 1230, the CU 1210, and/or the network unit 1000) such as described by the wireless communications network 100 and/or 1200.

In some aspects, the second reference signal(s) satisfying the second threshold may be associated with a reference signal group. The plurality of reference signals received from the network unit may be associated with directional beams. The directional beams may be grouped based on their respective direction and assigned a CMR group identifier. For example, a first CMR group 510(1) may include a number of adjacent beams, a second CMR group 510(2) may include a number of other adjacent beams, a third CMR group 510(n) may include a number of other adjacent beams, etc. The CSI report configuration may indicate the number of beams in a CMR group 510. The UE may determine which CMR groups 510 include a preconfigured number of reference signals satisfying the second threshold or other threshold (e.g., third threshold, fourth threshold, etc.) within the CMR group 510. In some instances, each of the thresholds (e.g., second threshold, third threshold, fourth threshold, etc.) may be associated with a different RSRP and/or SINR level. If the number of reference signals satisfying the second threshold or other threshold (e.g., third threshold, fourth threshold, etc.) within the CMR group 510 meets or exceeds the preconfigured number, then the UE may indicate the CMR group identifier(s) in the CSI report(s). The CSI report configuration may indicate the number of reference signals in a CMR group 510 that need to satisfy the second threshold or other threshold (e.g., third threshold, fourth threshold, etc.). The number of reference signals in a CMR group 510 that need to satisfy the second threshold or other threshold (e.g., third threshold, fourth threshold, etc.) may be preconfigured and/or dynamically configured. The CSI report may explicitly indicate the CMR group IDs that meet the number of reference signals satisfying the second threshold or other threshold (e.g., third threshold, fourth threshold, etc.). Additionally or alternatively, the CSI report may include a bitmap in which each bit corresponds to a CMR group ID (e.g., group 510(1), 510(2), 510(n)) that indicates whether the CMR group meets the preconfigured number of reference signals satisfying the second threshold or other threshold (e.g., third threshold, fourth threshold, etc.). If no group meets the number of reference signals satisfying the second threshold or other threshold (e.g., third threshold, fourth threshold, etc.), the bitmap may indicate all zeros (e.g., ‘0’).

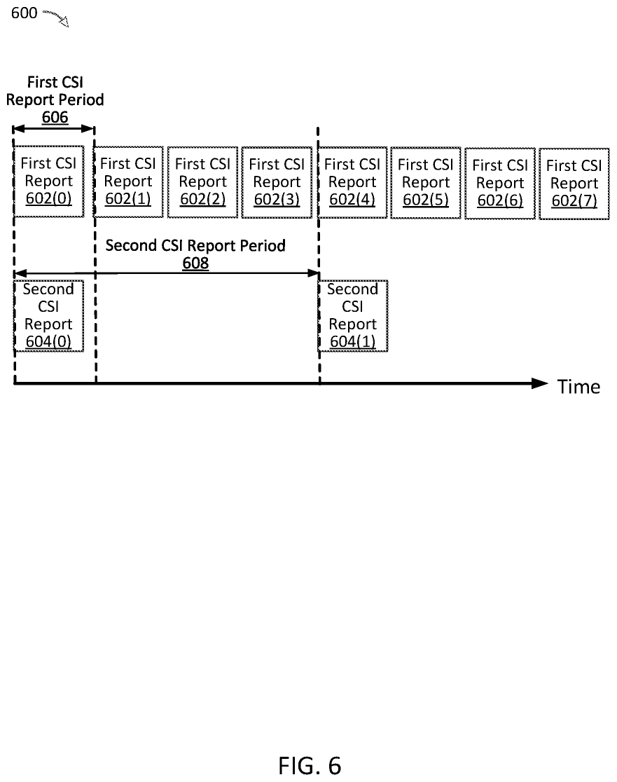

FIG. 6 illustrates an example of CSI reporting periods 600 according to some aspects of the present disclosure. The CSI reporting periods 600 may be implemented by aspects of the wireless communications network 100 and/or the wireless communications network 1200. For example, the CSI reporting periods 600 may be implemented for communications by one or more UEs, (e.g., UE 115, UE 120, or UE 900) such as described by the wireless communications network 100 and/or 1200. In FIG. 6, the x-axis represents time in some arbitrary units.

In some aspects, a UE may transmit at least one CSI report to the network unit based on the CSI report configuration. The first CSI report(s) 602 may indicate CMD-IDs of one or more first reference signals of the plurality of reference signals satisfying a first threshold. In some aspects, the second CSI report(s) 604 may indicate CMD-IDs of one or more second reference signals of the plurality of reference signals satisfying a second threshold.

The UE may transmit the CSI report(s) to the network unit using any suitable communication(s). For example, the UE may transmit one or more indicators of the first reference signal(s) satisfying the first threshold and the second reference signal(s) satisfying the second threshold in a single-part payload and/or a two-part payload via a physical uplink shared channel (PUSCH). In some aspects, the UE may transmit the indicator(s) of the first reference signal(s) satisfying the first threshold in a first part of a two-part payload via a physical uplink control channel (PUCCH), while the indicator(s) of the second reference signal(s) satisfying the second threshold are transmitted via a second part of the two-part payload via a PUSCH. In this case, the PUCCH may include a scheduling request for transmitting the second part via the PUSCH. In some aspects, the UE may transmit the indicator(s) of the first reference signal(s) satisfying the first threshold and the indicator(s) of the second reference signal(s) satisfying the second threshold in a single-part payload and/or a two-part payload via a PUCCH. For example, the UE may transmit the indicator(s) of the first reference signal(s) satisfying the first threshold and the indicator(s) of the second reference signal(s) satisfying the second threshold in a single-part payload via a PUCCH. Additionally or alternatively, the UE may transmit the indicator(s) of the first reference signal(s) satisfying the first threshold in the first part of the two-part payload via a PUCCH and transmit the indicator(s) of the second reference signal(s) satisfying the second threshold in the second part of the two-part payload via a PUCCH.

In some aspects, the UE may include the CMR-IDs of all reference signals satisfying a threshold in a CSI report. For example, the UE may include the CMR-IDs of all reference signals satisfying the second threshold or other threshold (e.g., a third threshold, a fourth threshold, etc.) in the associated CSI report. Additionally or alternatively, the CSI report configuration may indicate to the UE the number (e.g., a maximum number) of CMR-IDs to report. For example, the CSI report configuration may indicate to the UE to report up to 1, 2, 3, 4, etc. reference signals satisfying the second threshold or other threshold (e.g., third threshold, fourth threshold, etc.). If the total number of CMR-IDs satisfying the second threshold or other threshold (e.g., third threshold, fourth threshold, etc.) exceeds the number indicated in the CSI report configuration, then the UE may select the CMR-IDs to report based on the strongest second reference signals, the weakest second reference signals, sequentially, randomly, and/or using other suitable criteria. If the total number of CMR-IDs of the second reference signals satisfying the second threshold or other threshold (e.g., third threshold, fourth threshold, etc.) is less than the number indicated in the CSI report configuration, then the UE may report a reserved codepoint for the CMR-IDs that do not satisfy the second threshold or other threshold (e.g., third threshold, fourth threshold, etc.).

The UE may transmit the CSI report to the network unit based on a periodic basis and/or a semi-persistent basis. In this regard, the UE may receive an indicator from the network unit in the CSI report configuration from the network unit indicating a first CSI reporting periodicity 606 and/or a second CSI reporting periodicity 608 at which the UE may transmit the CSI report(s). When the CSI report configuration indicates that the CSI report(s) are to be transmitted on a semi-persistent basis, the CSI report configuration may include an activator that activates a particular periodicity for transmitting the CSI report(s). The UE may receive the CSI report configuration including the activator via a semi-persistent activation state configuration via a medium access control control element (MAC-CE), DCI, a radio resource control (RRC) message, a MAC-CE, a PDCCH message, a PDSCH message, or other suitable communication. In some aspects, when the UE transmits a first CSI report 602 and a second CSI report 604 to the network unit, the UE may transmit the first CSI report 602 indicating the first reference signals satisfying the first threshold at a first periodicity 606 and may transmit the second CSI report 604 indicating the second reference signals satisfying the second threshold at a second periodicity 608, which may be the same or different than the first periodicity 606. In some instances, the second CSI report 604 may be transmitted after the first CSI report 602 (e.g., within a time window after the first CSI report 602). In some aspects, the second CSI reporting periodicity 608 may be an integer multiple (e.g., 2, 4, 8, etc.) of the first CSI reporting periodicity 606. In some aspects, the first periodicity 606 and/or the second periodicity 608 may be based on the number of thresholds and/or the level of the thresholds (e.g., RSRP levels and/or SINR levels).

The first CSI report 602 indicating the first reference signal(s) satisfying the first threshold may be associated with the second CSI report 604 indicating the second reference signal(s) satisfying the second threshold. For example, the first reference signals and the second reference signals may be received by the UE in the same time window (e.g., the same symbol, the same slot, the same radio frame, etc.). In some aspects, the first CSI report 602 may be transmitted by the UE in the same time window (e.g., the same symbol, the same slot, the same radio frame, etc.) as the second CSI report 604. In some aspects, the second CSI report 604 may be transmitted just after the first CSI report 602. The first CSI report 602 may include a CSI report setting ID of the second CSI report 604 associating (e.g., linking) the first CSI report 602 to the second CSI report 604. Additionally or alternatively, the second CSI report 604 may include a CSI report setting ID of the first CSI report 602 associating (e.g., linking) the second CSI report 604 to the first CSI report 602.

In some aspects, the UE may transmit the first CSI report 602 and/or the second CSI report 604 to the network unit on an aperiodic basis. In this regard, the UE may receive a request from the network unit to transmit the first CSI report 602 and/or the second CSI report 604. The UE may receive the request to transmit the first CSI report 602 and/or the second CSI report 604 via an aperiodic triggering state configuration downlink control information (DCI), DCI, a radio resource control (RRC) message, a MAC-CE, a PDCCH message, a PDSCH message, or other suitable communication. The UE may transmit the first CSI report 602 and/or the second CSI report 604 to the network unit in response to the request (e.g., the trigger).

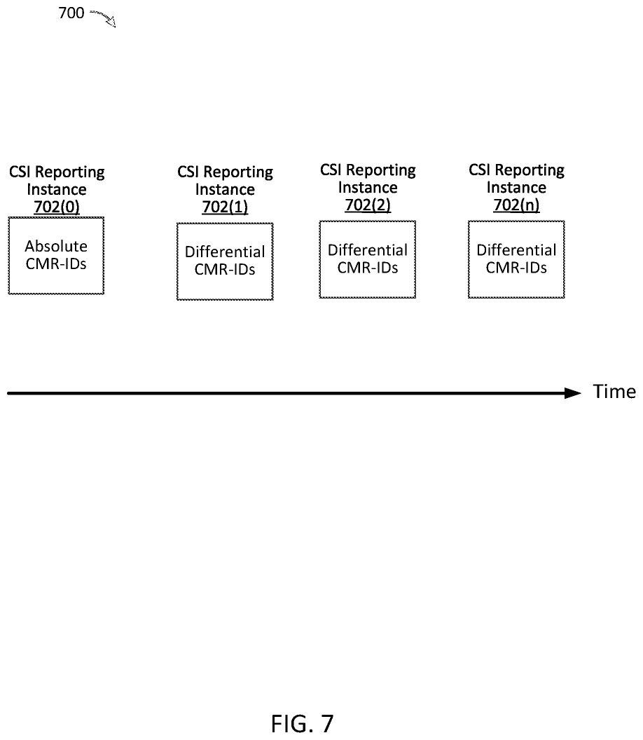

FIG. 7 illustrates an example of CSI reporting instances 700 according to some aspects of the present disclosure. The CSI reporting instances 700 may be implemented by aspects of the wireless communications network 100 and/or the wireless communications network 1200. For example, the CSI reporting instances 700 may be implemented for communications by one or more UEs, (e.g., UE 115, UE 120, or UE 900) such as described by the wireless communications network 100 and/or 1200. In FIG. 7, the x-axis represents time in some arbitrary units.

In some aspects, the UE may transmit a first CSI report, a second SI report and additional CSI reports (e.g., a third, a fourth, a fifth, or more CSI reports) indicating the additional reference signal(s) satisfying the second threshold relative to a previously transmitted CSI report. For example, the first CSI report (e.g., CSI reporting instance 720(0)) may indicate absolute CMR-IDs of the reference signal(s) of the second reference signal(s) satisfying the second threshold. A second CSI report (e.g., CSI reporting instance 720(1)) transmitted after the first CSI report may indicate additional reference signal(s) as differential CMR-IDs relative to the absolute CMR-IDs indicated in the first CSI report. A third CSI report (e.g., CSI reporting instance 720(2)) transmitted after the second CSI report may indicate additional reference signal(s) as differential CMR-IDs relative to the CMR-IDs indicated in the second CSI report. A fourth CSI report (e.g., CSI reporting instance 720(n)) transmitted after the third CSI report may indicate additional reference signal(s) as differential CMR-IDs relative to the CMR-IDs indicated in the third CSI report, etc. The UE may receive an indicator in the CSI report configuration from the network unit indicating the number of CSI reports the UE may transmit to the network unit within a time period (e.g., a slot, a number of slots, a radio frame, a number of radio frames). In some aspects, the number of CSI reports the UE may transmit to the network unit may be based on the number of thresholds and/or the level(s) of the thresholds (e.g., RSRP levels and/or SINR levels). For example, the first CSI report may include CMR-IDs of reference signals satisfying the first threshold, the second CSI report may include CMR-IDs of reference signals satisfying the second threshold, a third CSI report may include CMR-IDs of reference signals satisfying a third threshold, etc.

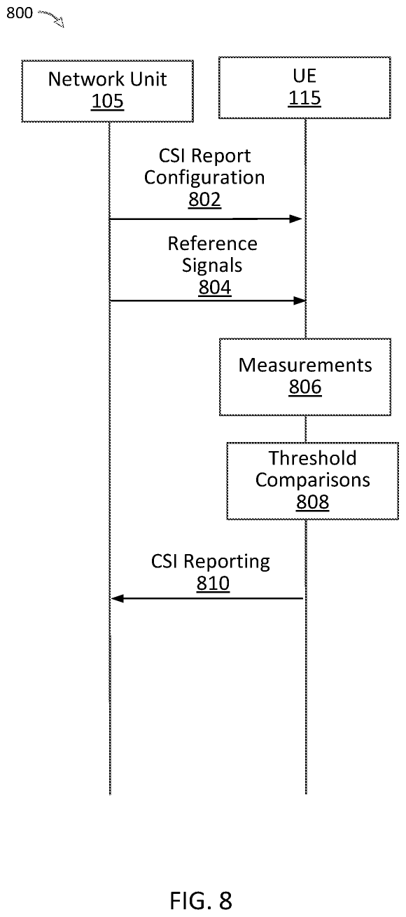

FIG. 8 is a signaling diagram of a wireless communication method 800 according to some aspects of the present disclosure. Actions of the communication method 800 can be executed by a computing device (e.g., a processor, processing circuit, and/or other suitable component) of a communication device or other suitable means for performing the actions. For example, a wireless communication device, such as the UE 115, UE 120, or UE 900, may utilize one or more components, such as the processor 902, the memory 904, the reference signal reporting module 908, the transceiver 910, the modem 912, and the one or more antennas 916, to execute aspects of method 800. A wireless communication device, such as the BS 105, the CU 1210, the DU 1230, the RU 1240, and/or the network unit 1000 may utilize one or more components, such as the processor 1002, the memory 1004, the reference signal reporting module 1008, the transceiver 1010, the modem 1012, and the one or more antennas 1016, to execute aspects of method 800.

At action 802, the network unit 105 may transmit a CSI report configuration to the UE 115. In this regard, the network unit 105 may transmit the CSI report configuration to the UE 115 via an aperiodic triggering state configuration downlink control information (DCI), DCI, a radio resource control (RRC) message, a semi-persistent activation state configuration via a medium access control control element (MAC-CE), a MAC-CE, a PDCCH message, a PDSCH message, or other suitable communication.

In some aspects, the CSI report configuration may indicate one or more threshold values. For example, the CSI report configuration may indicate a first threshold, a second threshold, a third threshold, etc. associated with the reference signal(s) (e.g., as described with reference to FIGS. 3, 4A, and 4B above). In some aspects, the CSI report configuration may indicate the number of CSI reports the UE 115 should transmit to the network unit 105 for each CSI reporting instance. The CSI report configuration may indicate one or more periodicities at which the network unit 105 may receive the CSI report(s) from the UE 115. The CSI report configuration may indicate a number of beams in a group.

At action 804, the network unit 105 may transmit reference signals to the UE 115. The reference signals may include channel state information reference signals (CSI-RSs), synchronization signal blocks (SSBs), and/or other reference signals. In some instances, the network unit may broadcast the PSS, the SSS, and/or the MIB in the form of synchronization signal blocks (SSBs) over a physical broadcast channel (PBCH). The reference signals may include zero power channel state information reference signals (ZP-CSI-RSs), non-zero power channel state information reference signals (NZP-CSI-RSs), and/or SSBs. Each of the reference signals may be identified by a channel measurement resource identifier (CMR-ID). The CSI-RS may be a reference signal used in the downlink direction for the purpose of channel sounding and may be used by the UE 115 to measure one or more characteristics of the radio channel.

At action 806, the UE 115 may perform measurements on the reference signals received at action 804. In this regard, the UE 115 may measure RSRP levels and/or SINR levels of the reference signals.

At action 808, the UE 115 may perform threshold comparisons on the reference signal measurements performed at action 806. Measurements of the reference signal(s) may be compared to the thresholds as described with reference to FIGS. 3 and 4 to determine if each the reference signal(s) satisfies a threshold. In some aspects, the thresholds may be represented as absolute values and/or relative values. For example, the thresholds may be represented as absolute values (e.g., dBm values). Additionally or alternatively, the thresholds may be represented as values (e.g., dB values) relative to other thresholds (e.g., relative to an absolute value and/or relative to another relative value).

At action 810, the UE 115 may transmit one or more CSI reports to the network unit 105 based on the threshold comparisons performed at action 810. In this regard, the UE 115 may transmit one or more CSI reports to the network unit 105 as described with reference to FIGS. 6 and 7.

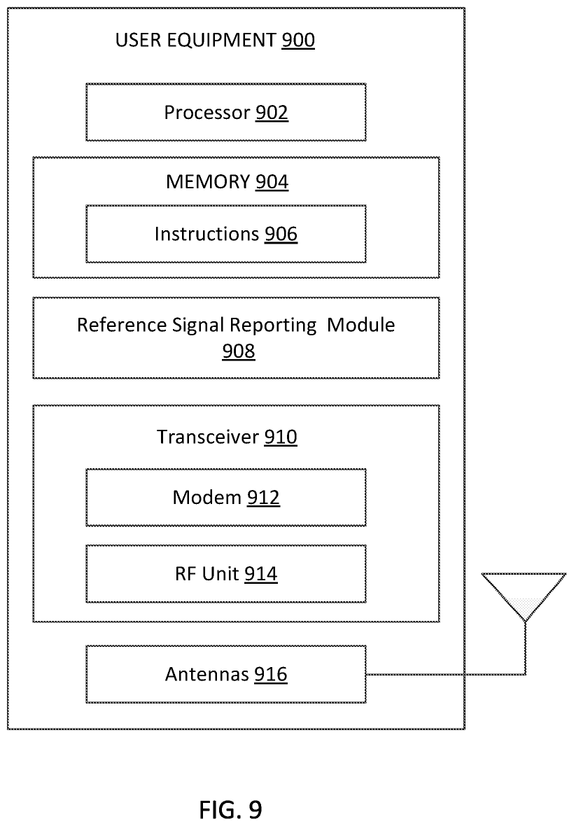

FIG. 9 is a block diagram of an exemplary UE 900 according to some aspects of the present disclosure. The UE 900 may be the UE 115 or the UE 120 in the network 100 or 1200 as discussed above. As shown, the UE 900 may include a processor 902, a memory 904, a reference signal reporting module 908, a transceiver 910 including a modem subsystem 912 and a radio frequency (RF) unit 914, and one or more antennas 916. These elements may be coupled with each other and in direct or indirect communication with each other, for example via one or more buses.

The processor 902 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 904 includes a non-transitory computer-readable medium. The memory 904 may store instructions 906. The instructions 906 may include instructions that, when executed by the processor 902, cause the processor 902 to perform the operations described herein with reference to the UEs 115 in connection with aspects of the present disclosure, for example, aspects of FIGS. 3-8. Instructions 906 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The reference signal reporting module 908 may be implemented via hardware, software, or combinations thereof. For example, the reference signal reporting module 908 may be implemented as a processor, circuit, and/or instructions 906 stored in the memory 904 and executed by the processor 902. In some aspects, the reference signal reporting module 908 may be used to receive, from a network unit (e.g., the BS 105, the RU 1240, the DU 1230, the CU 1210, or the network unit 1000), a channel state information (CSI) report configuration. The reference signal reporting module 908 may be used to receive, from the network unit, a plurality of reference signals. The reference signal reporting module 908 may be used to transmit, to the network unit based on the CSI report configuration, at least one CSI report, the at least one CSI report indicating one or more first reference signals of the plurality of reference signals satisfying a first threshold and one or more second reference signals of the plurality of reference signals satisfying a second threshold, wherein the second threshold is different from the first threshold.

As shown, the transceiver 910 may include the modem subsystem 912 and the RF unit 914. The transceiver 910 can be configured to communicate bi-directionally with other devices, such as the BSs 105 and/or the UEs 115. The modem subsystem 912 may be configured to modulate and/or encode the data from the memory 904 and the according to a modulation and coding scheme (MCS), e.g., a low-density parity check (LDPC) coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or a BS 105. The RF unit 914 may be further configured to perform analog beamforming in conjunction with the digital beamforming. Although shown as integrated together in transceiver 910, the modem subsystem 912 and the RF unit 914 may be separate devices that are coupled together to enable the UE 900 to communicate with other devices.

The RF unit 914 may provide the modulated and/or processed data, e.g. data packets (or, more generally, data messages that may contain one or more data packets and other information), to the antennas 916 for transmission to one or more other devices. The antennas 916 may further receive data messages transmitted from other devices. The antennas 916 may provide the received data messages for processing and/or demodulation at the transceiver 910. The antennas 916 may include multiple antennas of similar or different designs in order to sustain multiple transmission links. The RF unit 914 may configure the antennas 916.

In some instances, the UE 900 can include multiple transceivers 910 implementing different RATs (e.g., NR and LTE). In some instances, the UE 900 can include a single transceiver 910 implementing multiple RATs (e.g., NR and LTE). In some instances, the transceiver 910 can include various components, where different combinations of components can implement RATs.

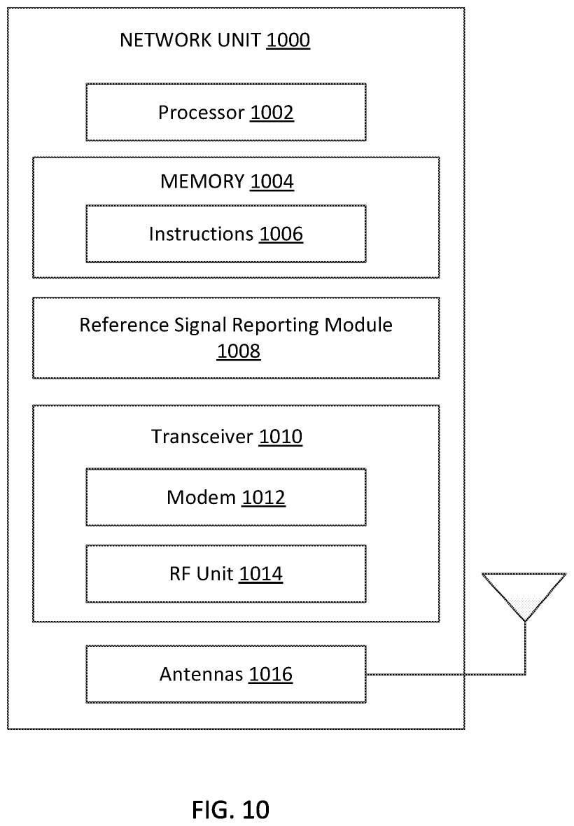

FIG. 10 is a block diagram of an exemplary network unit 1000 according to some aspects of the present disclosure. The network unit 1000 may be a BS 105, the CU 1210, the DU 1230, or the RU 1240, as discussed above. As shown, the network unit 1000 may include a processor 1002, a memory 1004, a reference signal reporting module 1008, a transceiver 1010 including a modem subsystem 1012 and a RF unit 1014, and one or more antennas 1016. These elements may be coupled with each other and in direct or indirect communication with each other, for example via one or more buses.

The processor 1002 may have various features as a specific-type processor. For example, these may include a CPU, a DSP, an ASIC, a controller, a FPGA device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 1004 may include a non-transitory computer-readable medium. The memory 1004 may store instructions 1006. The instructions 1006 may include instructions that, when executed by the processor 1002, cause the processor 1002 to perform operations described herein, for example, aspects of FIGS. 3-8. Instructions 1006 may also be referred to as code, which may be interpreted broadly to include any type of computer-readable statement(s).

The reference signal reporting module 1008 may be implemented via hardware, software, or combinations thereof. For example, the reference signal reporting module 1008 may be implemented as a processor, circuit, and/or instructions 1006 stored in the memory 1004 and executed by the processor 1002.

In some aspects, the reference signal reporting module 1008 may implement the aspects of FIGS. 3-8. For example, the reference signal reporting module 1008 may transmit, to a user equipment (UE), a channel state information (CSI) report configuration. The reference signal reporting module 1008 may transmit, to the UE, a plurality of reference signals. The reference signal reporting module 1008 may receive, from the UE, at least one CSI report based on the CSI report configuration, the at least one CSI report indicating one or more first reference signals of the plurality of reference signals satisfying a first threshold and one or more second reference signals of the plurality of reference signals satisfying a second threshold, wherein the second threshold is different from the first threshold.

Additionally or alternatively, the reference signal reporting module 1008 can be implemented in any combination of hardware and software, and may, in some implementations, involve, for example, processor 1002, memory 1004, instructions 1006, transceiver 1010, and/or modem 1012.

As shown, the transceiver 1010 may include the modem subsystem 1012 and the RF unit 1014. The transceiver 1010 can be configured to communicate bi-directionally with other devices, such as the UEs 115 and/or 600. The modem subsystem 1012 may be configured to modulate and/or encode data according to a MCS, e.g., a LDPC coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data from the modem subsystem 1012 (on outbound transmissions) or of transmissions originating from another source such as a UE 115 or UE 900. The RF unit 1014 may be further configured to perform analog beamforming in conjunction with the digital beamforming. Although shown as integrated together in transceiver 1010, the modem subsystem 1012 and/or the RF unit 1014 may be separate devices that are coupled together at the network unit 1000 to enable the network unit 1000 to communicate with other devices.

The RF unit 1014 may provide the modulated and/or processed data, e.g. data packets (or, more generally, data messages that may contain one or more data packets and other information), to the antennas 1016 for transmission to one or more other devices. This may include, for example, a configuration indicating a plurality of sub-slots within a slot according to aspects of the present disclosure. The antennas 1016 may further receive data messages transmitted from other devices and provide the received data messages for processing and/or demodulation at the transceiver 1010. The antennas 1016 may include multiple antennas of similar or different designs in order to sustain multiple transmission links.

In some instances, the network unit 1000 can include multiple transceivers 1010 implementing different RATs (e.g., NR and LTE). In some instances, the network unit 1000 can include a single transceiver 1010 implementing multiple RATs (e.g., NR and LTE). In some instances, the transceiver 1010 can include various components, where different combinations of components can implement RATs.

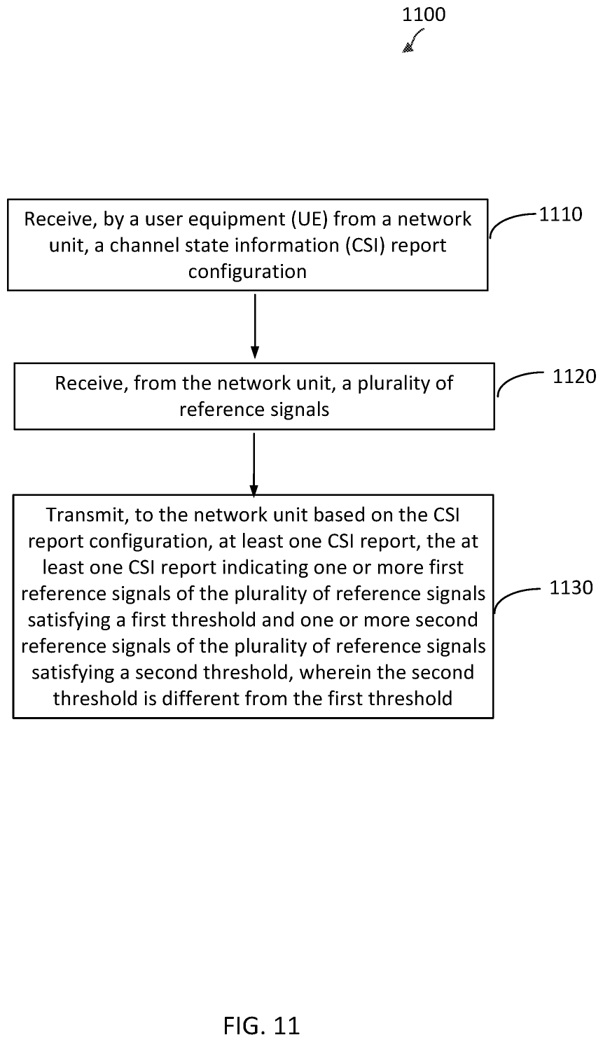

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the aspects. For example, a wireless communication device, such as the UE 115, the UE 120, or the UE 900, may utilize one or more components, such as the processor 902, the memory 904, the reference signal reporting module 908, the transceiver 910, the modem 912, and the one or more antennas 916, to execute aspects of method 1100. The method 1100 may employ similar mechanisms as in the networks 100 and 1200 and the aspects and actions described with respect to FIGS. 3-8. As illustrated, the method 1100 includes a number of enumerated aspects, but the method 1100 may include additional aspects before, after, and in between the enumerated aspects. In some aspects, one or more of the enumerated aspects may be omitted or performed in a different order.

At action 1110, the method 1100 includes a UE (e.g., the UE 115, the UE 120, or the UE 900) receiving a channel state information (CSI) report configuration from a network unit (e.g., the BS 105, the RU 1240, the DU 1230, the CU 1210, and/or the network unit 1000). In this regard, the UE may receive the CSI report configuration from the network unit via an aperiodic triggering state configuration downlink control information (DCI), DCI, a radio resource control (RRC) message, a semi-persistent activation state configuration via a medium access control control element (MAC-CE), a MAC-CE, a PDCCH message, a PDSCH message, or other suitable communication.

In some aspects, the CSI report configuration may indicate one or more threshold values. For example, the CSI report configuration may indicate a first threshold, a second threshold, a third threshold, etc. associated with the reference signal(s) (e.g., as described with reference to FIGS. 3, 4A, and 4B above). In some aspects, the CSI report configuration may indicate the number of CSI reports the UE should transmit to the network unit for each CSI reporting instance. The CSI report configuration may indicate one or more periodicities at which the UE may transmit the CSI report(s) to the network unit. The CSI report configuration may indicate a number of beams in a group.

At action 1120, the method 1100 includes a UE (e.g., the UE 115, the UE 120, or the UE 900) receiving a plurality of reference signals from the network unit. The plurality of reference signals may include channel state information reference signals (CSI-RSs), synchronization signal blocks (SSBs), and/or other reference signals. In some instances, the network unit may broadcast the PSS, the SSS, and/or the MIB in the form of synchronization signal blocks (SSBs) over a physical broadcast channel (PBCH). The reference signals may include zero power channel state information reference signals (ZP-CSI-RSs), non-zero power channel state information reference signals (NZP-CSI-RSs), and/or SSBs. Each of the reference signals may be identified by a channel measurement resource identifier (CMR-ID). The CSI-RS may be a reference signal used in the downlink direction for the purpose of channel sounding and may be used by the UE to measure one or more characteristics of the radio channel.

At action 1130, the method 1100 includes a UE transmitting, based on the CSI report configuration received at action 1110, at least one CSI report to the network unit. In some aspects, the CSI report(s) may indicate CMD-IDs of one or more first reference signals of the plurality of reference signals satisfying a first threshold. In some aspects, the CSI report(s) may indicate CMD-IDs of one or more second reference signals of the plurality of reference signals satisfying a second threshold. The second threshold may be different from the first threshold. Measurements of the reference signal(s) may be compared to the thresholds to determine if each the reference signal(s) satisfies a threshold. In some aspects, the thresholds may be represented as absolute values and/or relative values. For example, the thresholds may be represented as absolute values (e.g., dBm values). Additionally or alternatively, the thresholds may be represented as values (e.g., dB values) relative to other thresholds (e.g., relative to an absolute value and/or relative to another relative value).

The UE may transmit the CSI report(s) to the network unit using any suitable communication(s). For example, the UE may transmit one or more indicators of the first reference signal(s) satisfying the first threshold and the second reference signal(s) satisfying the second threshold in a single-part payload and/or a two-part payload via a physical uplink shared channel (PUSCH). In some aspects, the UE may transmit the indicator(s) of the first reference signal(s) satisfying the first threshold in a first part of a two-part payload via a physical uplink control channel (PUCCH), while the indicator(s) of the second reference signal(s) satisfying the second threshold are transmitted via a second part of the two-part payload via a PUSCH. In this case, the PUCCH may include a scheduling request for transmitting the second part via the PUSCH. In some aspects, the UE may transmit the indicator(s) of the first reference signal(s) satisfying the first threshold and the indicator(s) of the second reference signal(s) satisfying the second threshold in a single-part payload and/or a two-part payload via a PUCCH. For example, the UE may transmit the indicator(s) of the first reference signal(s) satisfying the first threshold and the indicator(s) of the second reference signal(s) satisfying the second threshold in a single-part payload via a PUCCH. Additionally or alternatively, the UE may transmit the indicator(s) of the first reference signal(s) satisfying the first threshold in the first part of the two-part payload via a PUCCH and transmit the indicator(s) of the second reference signal(s) satisfying the second threshold in the second part of the two-part payload via a PUCCH.

In some aspects, as described with reference to FIG. 7, the UE may transmit a first CSI report (e.g., CSI reporting instance 720(0)) comprising a CMR-ID associated with the second reference signal(s) satisfying the second threshold. In this regard, a baseline reference signal of the second reference signal(s) satisfying the second threshold may be reported in the first CSI report (e.g., CSI reporting instance 720(0)) as an absolute value of the CMR-ID. The UE may then subsequently transmit a second CSI report (e.g., CSI reporting instance 720(1)) after the first CSI report indicating one or more additional reference signals of the second reference signal(s) satisfying the second threshold. The second CSI report may indicate the additional reference signal(s) relative to the baseline reference signal of the second reference signal(s) satisfying the second threshold. For example, the second CSI report may indicate the additional reference signal(s) as an offset (e.g., a differential) to the CMR-ID associated with the baseline reference signal of the second reference signal(s) satisfying the second threshold. In some aspects, the UE may transmit additional CSI reports (e.g., a third CSI report such as CSI reporting instance 720(n), a fourth, a fifth, or more CSI reports) indicating one or more additional reference signals satisfying the second threshold relative to the baseline reference signal of the second reference signal(s) satisfying the second threshold reported in the first CSI report (e.g., CSI reporting instance 720(0)). The UE may receive an indicator in the CSI report configuration from the network unit at action 1110 indicating the number of CSI reports the UE may transmit to the network unit within a time period (e.g., a slot, a number of slots, a radio frame, a number of radio frames).

In some aspects, the number of CSI reports the UE may transmit to the network unit may be based on the number of thresholds and/or the level of the thresholds (e.g., RSRP levels and/or SINR levels). For example, the first CSI report may include CMR-IDs of reference signals satisfying the first threshold, the second CSI report may include CMR-IDs of reference signals satisfying the second threshold, a third CSI report may include CMR-IDs of reference signals satisfying a third threshold, etc.

Additionally or alternatively, as described with reference to FIG. 7, the UE may transmit additional CSI reports (e.g., a third, a fourth, a fifth, or more CSI reports) indicating the additional reference signal(s) satisfying the second threshold relative to a previously transmitted CSI report. For example, the first CSI report (e.g., CSI reporting instance 720(0)) may indicate absolute CMR-IDs of the reference signal(s) of the second reference signal(s) satisfying the second threshold. A second CSI report (e.g., CSI reporting instance 720(1)) transmitted after the first CSI report may indicate additional reference signal(s) as differential CMR-IDs relative to the absolute CMR-IDs indicated in the first CSI report. A third CSI report (e.g., CSI reporting instance 720(n)) transmitted after the second CSI report may indicate additional reference signal(s) as differential CMR-IDs relative to the CMR-IDs indicated in the second CSI report. A fourth CSI report (e.g., CSI reporting instance 720(n)) transmitted after the third CSI report may indicate additional reference signal(s) as differential CMR-IDs relative to the CMR-IDs indicated in the third CSI report, etc. The UE may receive an indicator in the CSI report configuration from the network unit at action 1110 indicating the number of CSI reports the UE may transmit to the network unit within a time period (e.g., a slot, a number of slots, a radio frame, a number of radio frames). In some aspects, the number of CSI reports the UE may transmit to the network unit may be based on the number of thresholds and/or the level(s) of the thresholds (e.g., RSRP levels and/or SINR levels). For example, the first CSI report may include CMR-IDs of reference signals satisfying the first threshold, the second CSI report may include CMR-IDs of reference signals satisfying the second threshold, a third CSI report may include CMR-IDs of reference signals satisfying a third threshold, etc.

In some aspects, the UE may include the CMR-IDs of all reference signals satisfying a threshold in a CSI report. For example, the UE may include the CMR-IDs of all reference signals satisfying the second threshold or other threshold (e.g., a third threshold, a fourth threshold, etc.) in the associated CSI report. Additionally or alternatively, the CSI report configuration may indicate to the UE the number (e.g., a maximum number) of CMR-IDs to report. For example, the CSI report configuration may indicate to the UE to report up to 1, 2, 3, 4, etc. reference signals satisfying the second threshold or other threshold (e.g., third threshold, fourth threshold, etc.). If the total number of CMR-IDs satisfying the second threshold or other threshold (e.g., third threshold, fourth threshold, etc.) exceeds the number indicated in the CSI report configuration, then the UE may select the CMR-IDs to report based on the strongest second reference signals, the weakest second reference signals, sequentially, randomly, and/or using other suitable criteria. If the total number of CMR-IDs of the second reference signals satisfying the second threshold or other threshold (e.g., third threshold, fourth threshold, etc.) is less than the number indicated in the CSI report configuration, then the UE may report a reserved codepoint for the CMR-IDs that do not satisfy the second threshold or other threshold (e.g., third threshold, fourth threshold, etc.).

The UE may transmit the CSI report to the network unit based on a periodic basis and/or a semi-persistent basis. In this regard, the UE may receive an indicator from the network unit in the CSI report configuration from the network unit at action 1110 indicating the periodicity at which the UE may transmit the CSI report(s). When the CSI report configuration indicates that the CSI report(s) are to be transmitted on a semi-persistent basis, the CSI report configuration may include an activator that activates a particular periodicity for transmitting the CSI report(s). The UE may receive the CSI report configuration including the activator via a semi-persistent activation state configuration via a medium access control control element (MAC-CE), DCI, a radio resource control (RRC) message, a MAC-CE, a PDCCH message, a PDSCH message, or other suitable communication. In some aspects, when the UE transmits a first CSI report and a second CSI report to the network unit, the UE may transmit the first CSI report indicating the first reference signals satisfying the first threshold at a first periodicity and may transmit the second CSI report indicating the second reference signals satisfying the second threshold at a second periodicity, which may be the same or different than the first periodicity. In some instances, the second CSI report may be transmitted after the first CSI report (e.g., within a time window after the first CSI report). In some aspects, the second periodicity may be an integer multiple (e.g., 2, 4, 8, etc.) of the first periodicity. In some aspects, the first periodicity and/or the second periodicity may be based on the number of thresholds and/or the level of the thresholds (e.g., RSRP levels and/or SINR levels).

The first CSI report indicating the first reference signal(s) satisfying the first threshold may be associated with the second CSI report indicating the second reference signal(s) satisfying the second threshold. For example, the first reference signals and the second reference signals may be received by the UE in the same time window (e.g., the same symbol, the same slot, the same radio frame, etc.). In some aspects, the first CSI report may be transmitted by the UE in the same time window (e.g., the same symbol, the same slot, the same radio frame, etc.) as the second CSI report. The first CSI report may include a CSI report setting ID of the second CSI report associating (e.g., linking) the first CSI report to the second CSI report. The second CSI report may include a CSI report setting ID of the first CSI report associating (e.g., linking) the second CSI report to the first CSI report. In some aspects, the CMR-IDs of the second reference signals may be associated with CMR-IDs of the first reference signals having a strongest RSRP.

In some aspects, the UE may transmit the CSI report(s), at action 1130, to the network unit on an aperiodic basis. In this regard, the UE may receive a request from the network unit to transmit the CSI report(s). The UE may receive the request to transmit the CSI report(s) via an aperiodic triggering state configuration downlink control information (DCI), DCI, a radio resource control (RRC) message, a MAC-CE, a PDCCH message, a PDSCH message, or other suitable communication. The UE may transmit the CSI report(s) to the network unit in response to the request (e.g., the trigger).

In some aspects, as described with reference to FIG. 5, the second reference signal(s) satisfying the second threshold may be associated with a reference signal group. The plurality of reference signals received from the network unit, at action 1120, may be associated with directional beams. The directional beams may be grouped based on their respective direction and assigned a group identifier. For example, a first group (e.g., group 510(1)) may include a number of adjacent beams, a second group (e.g., group 510(2)) may include a number of other adjacent beams, a third group (e.g., group 510(n)) may include a number of other adjacent beams, etc. The CSI report configuration, received at action 1110, may indicate the number of beams in a group. The UE may determine which groups include a preconfigured number of reference signals satisfying the second threshold or other threshold (e.g., third threshold, fourth threshold, etc.) within the group. In some instances, each of the thresholds (e.g., second threshold, third threshold, fourth threshold, etc.) may be associated with a different RSRP and/or SINR level. If the number of reference signals satisfying the second threshold or other threshold (e.g., third threshold, fourth threshold, etc.) within the group meets or exceeds the preconfigured number, then the UE may indicate the group identifier(s) in the CSI report(s), at action 1130. The CSI report configuration, received at action 1110, may indicate the number of reference signals in a group that need to satisfy the second threshold or other threshold (e.g., third threshold, fourth threshold, etc.). The number of reference signals in a group that need to satisfy the second threshold or other threshold (e.g., third threshold, fourth threshold, etc.) may be preconfigured and/or dynamically configured. The CSI report may explicitly indicate the group IDs that meet the number of reference signals satisfying the second threshold or other threshold (e.g., third threshold, fourth threshold, etc.). Additionally or alternatively, the CSI report may include a bitmap in which each bit corresponds to a group ID (e.g., group 510(1), 510(2), 510(n)) that indicates whether the group meets the preconfigured number of reference signals satisfying the second threshold or other threshold (e.g., third threshold, fourth threshold, etc.). If no group meets the number of reference signals satisfying the second threshold or other threshold (e.g., third threshold, fourth threshold, etc.), the bitmap may indicate all zeros (e.g., ‘0’).

In some aspects, the CSI report(s), transmitted at action 1130, may indicate the first reference signal(s) of the plurality of reference signals satisfying a first threshold. In this regard, satisfying the first threshold may include an RSRP of the first reference signal(s) being greater than (or greater than or equal to) the first threshold and/or an SINR of the first reference signal(s) being greater than (or greater than or equal to) the first threshold.

In some aspects, the CSI report(s), transmitted at action 1130, may indicate the second reference signal(s) of the plurality of reference signals satisfying a second threshold. In this regard, satisfying the second threshold may include an RSRP of the second reference signal(s) being greater than (or greater than or equal to) the second threshold and less than (or less than or equal to) the first threshold. Additionally or alternatively, satisfying the second threshold may include an SINR of the second reference signal(s) being greater than (or greater than or equal to) the second threshold and less than (or less than or equal to) the first threshold. In some aspects, the CSI report(s), transmitted at action 1130, may indicate the additional reference signal(s) that satisfy a third threshold, a fourth threshold, and/or other thresholds.

In some aspects, as described with reference to FIGS. 3, 4A, and 4B, the first threshold (e.g., threshold 312(1)) may be based on a first offset (e.g., offset 414(1) from a measurement associated with a reference signal (e.g., SSB 310(4)) of the first reference signals satisfying the first threshold. For example, the measurement associated with a reference signal (e.g., SSB 310(4)) of the first reference signals satisfying the first threshold may include the lowest RSRP measurement (e.g., the weakest RSRP) associated with the first reference signals (e.g., a set of first reference signals SSB 310(4) and SSB 310(5)) that are the strongest of the first reference signals greater than the first threshold (e.g., threshold 312(1)). The CSI report configuration may indicate the number of reference signals (e.g., two reference signals) in the set of first reference signals. The CSI report(s) may include CMR-IDs of the set of first reference signals that are the strongest of the first reference signals greater than the first threshold. The first threshold may be determined relative to the strength of the weakest reference signal (e.g., SSB 310(4)) among the set of first reference signals that are the strongest of the first reference signals. For example, the first threshold may be set based on a number of decibels lower (e.g., −10 dB lower, −20 dB lower, etc.) than the strength of the weakest reference signal among the set of first reference signals that are the strongest of the first reference signals. The second threshold (e.g., threshold 312(2)) may be set based on a number of decibels lower (e.g., −10 dB lower, −20 dB lower, etc.) than the first threshold. In some aspects, a third threshold (e.g., threshold 312(k−1)) may be set based on a number of decibels lower (e.g., −10 dB lower, −20 dB lower, etc.) than the second threshold. In some aspects, a fourth threshold, a fifth, threshold, etc. may be set in a similar relative fashion.

In some aspects, the UE may report the CMR-IDs of reference signals satisfying a threshold (e.g., a first threshold, a second threshold, a third threshold, a fourth, threshold etc.) to a network unit enabling the network unit to predict a blockage associated with certain beams.

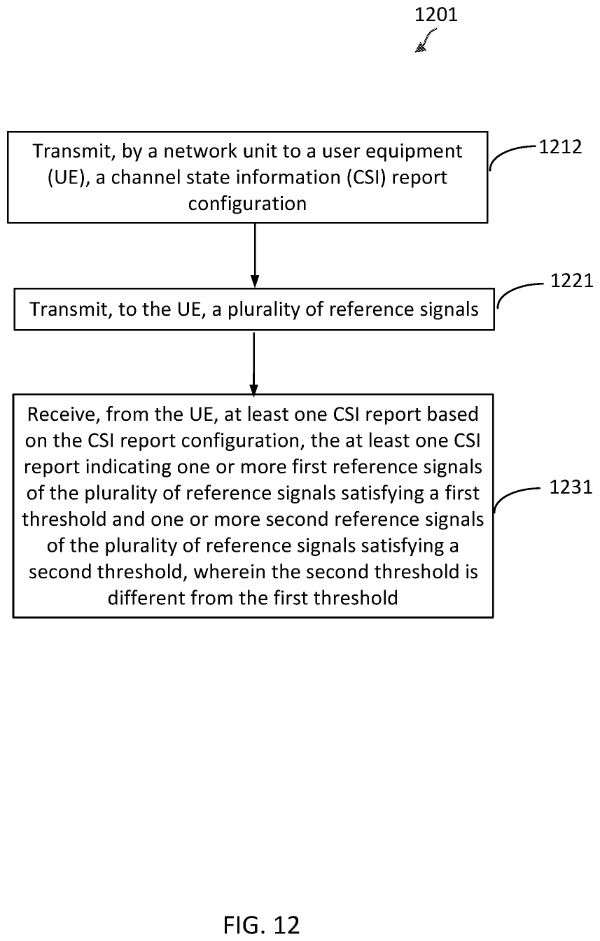

FIG. 12 is a flow diagram of a communication method 1201 according to some aspects of the present disclosure. Aspects of the method 1201 can be executed by a computing device (e.g., a processor, processing circuit, and/or other suitable component) of a wireless communication device or other suitable means for performing the aspects. For example, a wireless communication device, such as the BS 105, the RU 1240, the DU 1230, the CU 1210, and/or the network unit 1000, may utilize one or more components, such as the processor 1002, the memory 1004, the reference signal reporting module 1008, the transceiver 1010, the modem 1012, and the one or more antennas 1016, to execute aspects of method 1201. The method 1201 may employ similar mechanisms as in the networks 100 and 1200 and the aspects and actions described with respect to FIGS. 3-8. As illustrated, the method 1201 includes a number of enumerated aspects, but the method 1201 may include additional aspects before, after, and in between the enumerated aspects. In some aspects, one or more of the enumerated aspects may be omitted or performed in a different order.

At action 1212, the method 1201 includes a network unit (e.g., the BS 105, the RU 1240, the DU 1230, the CU 1210, and/or the network unit 1000) transmitting to a UE (e.g., the UE 115, the UE 120, or the UE 900) a channel state information (CSI) report configuration. In this regard, the network unit may transmit the CSI report configuration to the UE via an aperiodic triggering state configuration downlink control information (DCI), DCI, a radio resource control (RRC) message, a semi-persistent activation state configuration via a medium access control control element (MAC-CE), a MAC-CE, a PDCCH message, a PDSCH message, or other suitable communication.

In some aspects, the CSI report configuration may indicate one or more threshold values. For example, the CSI report configuration may indicate a first threshold, a second threshold, a third threshold, etc. associated with the reference signal(s) (e.g., as described with reference to FIGS. 3, 4A, and 4B above). In some aspects, the CSI report configuration may indicate the number of CSI reports the UE should transmit to the network unit for each CSI reporting instance. The CSI report configuration may indicate one or more periodicities at which the network unit may receive the CSI report(s) from the UE. The CSI report configuration may indicate a number of beams in a group.

At action 1221, the method 1201 includes a network unit transmitting a plurality of reference signals to a UE. The plurality of reference signals may include channel state information reference signals (CSI-RSs), synchronization signal blocks (SSBs), and/or other reference signals. In some instances, the network unit may broadcast the PSS, the SSS, and/or the MIB in the form of synchronization signal blocks (SSBs) over a physical broadcast channel (PBCH). The reference signals may include zero power channel state information reference signals (ZP-CSI-RSs), non-zero power channel state information reference signals (NZP-CSI-RSs), and/or SSBs. Each of the reference signals may be identified by a channel measurement resource identifier (CMR-ID). The CSI-RS may be a reference signal used in the downlink direction for the purpose of channel sounding and may be used by the UE to measure one or more characteristics of the radio channel.

At action 1231, the method 1201 includes a network unit receiving, based on the CSI report configuration transmitted at action 1212, at least one CSI from the UE. In some aspects, the CSI report(s) may indicate CMD-IDs of one or more first reference signals of the plurality of reference signals satisfying a first threshold. In some aspects, the CSI report(s) may indicate CMD-IDs of one or more second reference signals of the plurality of reference signals satisfying a second threshold. The second threshold may be different from the first threshold. Measurements of the reference signal(s) may be compared to the thresholds to determine if each the reference signal(s) satisfies a threshold. In some aspects, the thresholds may be represented as absolute values and/or relative values. For example, the thresholds may be represented as absolute values (e.g., dBm values). Additionally or alternatively, the thresholds may be represented as values (e.g., dB values) relative to other thresholds (e.g., relative to an absolute value and/or relative to another relative value).

The network unit may receive the CSI report(s) from the UE using any suitable communication(s). For example, the network unit may receive one or more indicators of the first reference signal(s) satisfying the first threshold and the second reference signal(s) satisfying the second threshold in a single-part payload and/or a two-part payload via a physical uplink shared channel (PUSCH). In some aspects, the network unit may receive the indicator(s) of the first reference signal(s) satisfying the first threshold in a first part of a two-part payload via a physical uplink control channel (PUCCH), while the indicator(s) of the second reference signal(s) satisfying the second threshold are received via a second part of the two-part payload via a PUSCH. In this case, the PUCCH may include a scheduling request for transmitting the second part via the PUSCH. In some aspects, the network unit may receive the indicator(s) of the first reference signal(s) satisfying the first threshold and the indicator(s) of the second reference signal(s) satisfying the second threshold in a single-part payload and/or a two-part payload via a PUCCH. For example, the network unit may receive the indicator(s) of the first reference signal(s) satisfying the first threshold and the indicator(s) of the second reference signal(s) satisfying the second threshold in a single-part payload via a PUCCH. Additionally or alternatively, the network unit may receive the indicator(s) of the first reference signal(s) satisfying the first threshold in the first part of the two-part payload via a PUCCH and receive the indicator(s) of the second reference signal(s) satisfying the second threshold in the second part of the two-part payload via a PUCCH.

In some aspects, as described with reference to FIG. 7, the network unit may receive a first CSI report (e.g., CSI reporting instance 720(0)) comprising a CMR-ID associated with the second reference signal(s) satisfying the second threshold. In this regard, a baseline reference signal of the second reference signal(s) satisfying the second threshold may be reported in the first CSI report (e.g., CSI reporting instance 720(0)) as an absolute value of the CMR-ID. The network unit may then subsequently receive a second CSI report (e.g., CSI reporting instance 720(1)) after the first CSI report indicating one or more additional reference signals of the second reference signal(s) satisfying the second threshold. The second CSI report may indicate the additional reference signal(s) relative to the baseline reference signal of the second reference signal(s) satisfying the second threshold. For example, the second CSI report may indicate the additional reference signal(s) as an offset (e.g., a differential) to the CMR-ID associated with the baseline reference signal of the second reference signal(s) satisfying the second threshold. In some aspects, the network unit may receive additional CSI reports (e.g., a third CSI report such as CSI reporting instance 720(n), a fourth, a fifth, or more CSI reports) indicating one or more additional reference signals satisfying the second threshold relative to the baseline reference signal of the second reference signal(s) satisfying the second threshold reported in the first CSI report (e.g., CSI reporting instance 720(0)). The network unit may transmit an indicator in the CSI report configuration to the UE at action 1212 indicating the number of CSI reports the UE may transmit to the network unit within a time period (e.g., a slot, a number of slots, a radio frame, a number of radio frames).

In some aspects, the number of CSI reports the network unit may receive from the UE may be based on the number of thresholds and/or the level of the thresholds (e.g., RSRP levels and/or SINR levels). For example, the first CSI report may include CMR-IDs of reference signals satisfying the first threshold, the second CSI report may include CMR-IDs of reference signals satisfying the second threshold, a third CSI report may include CMR-IDs of reference signals satisfying a third threshold, etc.

Additionally or alternatively, as described with reference to FIG. 7, the network unit may receive additional CSI reports (e.g., a third, a fourth, a fifth, or more CSI reports) indicating the additional reference signal(s) satisfying the second threshold relative to a previously transmitted CSI report. For example, the first CSI report (e.g., CSI reporting instance 720(0)) may indicate absolute CMR-IDs of the reference signal(s) of the second reference signal(s) satisfying the second threshold. A second CSI report (e.g., CSI reporting instance 720(1)) received after the first CSI report may indicate additional reference signal(s) as differential CMR-IDs relative to the absolute CMR-IDs indicated in the first CSI report. A third CSI report (e.g., CSI reporting instance 720(n)) received after the second CSI report may indicate additional reference signal(s) as differential CMR-IDs relative to the CMR-IDs indicated in the second CSI report. A fourth CSI report (e.g., CSI reporting instance 720(n)) received after the third CSI report may indicate additional reference signal(s) as differential CMR-IDs relative to the CMR-IDs indicated in the third CSI report, etc. The network unit may transmit an indicator in the CSI report configuration to the UE at action 1212 indicating the number of CSI reports the UE may transmit to the network unit within a time period (e.g., a slot, a number of slots, a radio frame, a number of radio frames). In some aspects, the number of CSI reports the UE may transmit to the network unit may be based on the number of thresholds and/or the level(s) of the thresholds (e.g., RSRP levels and/or SINR levels). For example, the first CSI report may include CMR-IDs of reference signals satisfying the first threshold, the second CSI report may include CMR-IDs of reference signals satisfying the second threshold, a third CSI report may include CMR-IDs of reference signals satisfying a third threshold, etc.

In some aspects, the UE may include the CMR-IDs of all reference signals satisfying a threshold in a CSI report. For example, the UE may include the CMR-IDs of all reference signals satisfying the second threshold or other threshold (e.g., a third threshold, a fourth threshold, etc.) in the associated CSI report. Additionally or alternatively, the CSI report configuration may indicate to the UE the number (e.g., a maximum number) of CMR-IDs to report. For example, the CSI report configuration may indicate to the UE to report up to 1, 2, 3, 4, etc. reference signals satisfying the second threshold or other threshold (e.g., third threshold, fourth threshold, etc.). If the total number of CMR-IDs satisfying the second threshold or other threshold (e.g., third threshold, fourth threshold, etc.) exceeds the number indicated in the CSI report configuration, then the UE may select the CMR-IDs to report based on the strongest second reference signals, the weakest second reference signals, sequentially, randomly, and/or using other suitable criteria. If the total number of CMR-IDs of the second reference signals satisfying the second threshold or other threshold (e.g., third threshold, fourth threshold, etc.) is less than the number indicated in the CSI report configuration, then the UE may report a reserved codepoint for the CMR-IDs that do not satisfy the second threshold or other threshold (e.g., third threshold, fourth threshold, etc.).

The network unit may receive the CSI report from the UE based on a periodic basis and/or a semi-persistent basis. In this regard, the network unit may transmit an indicator to the UE in the CSI report configuration at action 1212 indicating the periodicity at which the UE may transmit the CSI report(s). When the CSI report configuration indicates that the CSI report(s) are to be transmitted on a semi-persistent basis, the CSI report configuration may include an activator that activates a particular periodicity for transmitting the CSI report(s). The network unit may transmit the CSI report configuration including the activator via a semi-persistent activation state configuration via a medium access control control element (MAC-CE), DCI, a radio resource control (RRC) message, a MAC-CE, a PDCCH message, a PDSCH message, or other suitable communication. In some aspects, when the network unit may receives a first CSI report and a second CSI report from the UE, the network unit may receive the first CSI report indicating the first reference signals satisfying the first threshold at a first periodicity and may receive the second CSI report indicating the second reference signals satisfying the second threshold at a second periodicity, which may be the same or different than the first periodicity. In some instances, the second CSI report may be received after the first CSI report (e.g., within a time window after the first CSI report). In some aspects, the second periodicity may be an integer multiple (e.g., 2, 4, 8, etc.) of the first periodicity. In some aspects, the first periodicity and/or the second periodicity may be based on the number of thresholds and/or the level of the thresholds (e.g., RSRP levels and/or SINR levels).

The first CSI report indicating the first reference signal(s) satisfying the first threshold may be associated with the second CSI report indicating the second reference signal(s) satisfying the second threshold. For example, the first reference signals and the second reference signals may be transmitted by the network unit in the same time window (e.g., the same symbol, the same slot, the same radio frame, etc.). In some aspects, the first CSI report may be received by the network unit in the same time window (e.g., the same symbol, the same slot, the same radio frame, etc.) as the second CSI report. The first CSI report may include a CSI report setting ID of the second CSI report associating (e.g., linking) the first CSI report to the second CSI report. The second CSI report may include a CSI report setting ID of the first CSI report associating (e.g., linking) the second CSI report to the first CSI report. In some aspects, the CMR-IDs of the second reference signals may be associated with CMR-IDs of the first reference signals having a strongest RSRP.

In some aspects, the network unit may receive the CSI report(s), at action 1231, from the UE on an aperiodic basis. In this regard, the network unit may transmit a request to the UE to transmit the CSI report(s). The network unit may transmit the request to transmit the CSI report(s) via an aperiodic triggering state configuration downlink control information (DCI), DCI, a radio resource control (RRC) message, a MAC-CE, a PDCCH message, a PDSCH message, or other suitable communication. The network unit may receive the CSI report(s) from the UE in response to the request (e.g., the trigger).

In some aspects, as described with reference to FIG. 5, the second reference signal(s) satisfying the second threshold may be associated with a reference signal group. The plurality of reference signals transmitted by the network unit, at action 1221, may be associated with directional beams. The directional beams may be grouped based on their respective direction and assigned a group identifier. For example, a first group (e.g., group 510(1)) may include a number of adjacent beams, a second group (e.g., group 510(2)) may include a number of other adjacent beams, a third group (e.g., group 510(n)) may include a number of other adjacent beams, etc. The CSI report configuration, transmitted at action 1212, may indicate the number of beams in a group. The UE may determine which groups include a preconfigured number of reference signals satisfying the second threshold or other threshold (e.g., third threshold, fourth threshold, etc.) within the group. In some instances, each of the thresholds (e.g., second threshold, third threshold, fourth threshold, etc.) may be associated with a different RSRP and/or SINR level. If the number of reference signals satisfying the second threshold or other threshold (e.g., third threshold, fourth threshold, etc.) within the group meets or exceeds the preconfigured number, then the UE may indicate the group identifier(s) in the CSI report(s), at action 1231. The CSI report configuration, transmitted at action 1212, may indicate the number of reference signals in a group that need to satisfy the second threshold or other threshold (e.g., third threshold, fourth threshold, etc.). The number of reference signals in a group that need to satisfy the second threshold or other threshold (e.g., third threshold, fourth threshold, etc.) may be preconfigured and/or dynamically configured. The CSI report may explicitly indicate the group IDs that meet the number of reference signals satisfying the second threshold or other threshold (e.g., third threshold, fourth threshold, etc.). Additionally or alternatively, the CSI report may include a bitmap in which each bit corresponds to a group ID (e.g., group 510(1), 510(2), 510(n)) that indicates whether the group meets the preconfigured number of reference signals satisfying the second threshold or other threshold (e.g., third threshold, fourth threshold, etc.). If no group meets the number of reference signals satisfying the second threshold or other threshold (e.g., third threshold, fourth threshold, etc.), the bitmap may indicate all zeros (e.g., ‘0’).

In some aspects, the CSI report(s), received at action 1231, may indicate the first reference signal(s) of the plurality of reference signals satisfying a first threshold. In this regard, satisfying the first threshold may include an RSRP of the first reference signal(s) being greater than (or greater than or equal to) the first threshold and/or an SINR of the first reference signal(s) being greater than (or greater than or equal to) the first threshold.

In some aspects, the CSI report(s), received at action 1231, may indicate the second reference signal(s) of the plurality of reference signals satisfying a second threshold. In this regard, satisfying the second threshold may include an RSRP of the second reference signal(s) being greater than (or greater than or equal to) the second threshold and less than (or less than or equal to) the first threshold. Additionally or alternatively, satisfying the second threshold may include an SINR of the second reference signal(s) being greater than (or greater than or equal to) the second threshold and less than (or less than or equal to) the first threshold. In some aspects, the CSI report(s), received at action 1231, may indicate the additional reference signal(s) that satisfy a third threshold, a fourth threshold, and/or other thresholds.

In some aspects, as described with reference to FIGS. 3, 4A, and 4B, the first threshold (e.g., threshold 312(1)) may be based on a first offset (e.g., offset 414(1) from a measurement associated with a reference signal (e.g., SSB 310(4)) of the first reference signals satisfying the first threshold. For example, the measurement associated with a reference signal (e.g., SSB 310(4)) of the first reference signals satisfying the first threshold may include the lowest RSRP measurement (e.g., the weakest RSRP) associated with the first reference signals (e.g., a set of first reference signals SSB 310(4) and SSB 310(5)) that are the strongest of the first reference signals greater than the first threshold (e.g., threshold 312(1)). The CSI report configuration may indicate the number of reference signals (e.g., two reference signals) in the set of first reference signals. The CSI report(s) may include CMR-IDs of the set of first reference signals that are the strongest of the first reference signals greater than the first threshold. The first threshold may be determined relative to the strength of the weakest reference signal (e.g., SSB 310(4)) among the set of first reference signals that are the strongest of the first reference signals. For example, the first threshold may be set based on a number of decibels lower (e.g., −10 dB lower, −20 dB lower, etc.) than the strength of the weakest reference signal among the set of first reference signals that are the strongest of the first reference signals. The second threshold (e.g., threshold 312(2)) may be set based on a number of decibels lower (e.g., −10 dB lower, −20 dB lower, etc.) than the first threshold. In some aspects, a third threshold (e.g., threshold 312(k−1)) may be set based on a number of decibels lower (e.g., −10 dB lower, −20 dB lower, etc.) than the second threshold. In some aspects, a fourth threshold, a fifth, threshold, etc. may be set in a similar relative fashion.

In some aspects, the UE may report the CMR-IDs of reference signals satisfying a threshold (e.g., a first threshold, a second threshold, a third threshold, a fourth, threshold etc.) to a network unit enabling the network unit to predict a blockage associated with certain beams.

Further aspects of the present disclosure include the following:

Aspect 1 includes a method of wireless communication performed by a user equipment (UE), the method comprising receiving, from a network unit, a channel state information (CSI) report configuration; receiving, from the network unit, a plurality of reference signals; and transmitting, to the network unit based on the CSI report configuration, at least one CSI report, the at least one CSI report indicating one or more first reference signals of the plurality of reference signals satisfying a first threshold; and one or more second reference signals of the plurality of reference signals satisfying a second threshold, wherein the second threshold is different from the first threshold.

Aspect 2 includes the method of aspect 1, wherein the at least one CSI report indicating the one or more first reference signals satisfying the first threshold comprises a channel measurement resource identifier (CMR-ID) associated with the one or more first reference signals satisfying the first threshold; and the at least one CSI report indicating the one or more second reference signals satisfying the second threshold comprises a CMR-ID associated with the one or more second reference signals satisfying the second threshold.

Aspect 3 includes the method of any of aspects 1-2, wherein the one or more first reference signals satisfying the first threshold comprises at least one of a reference signal received power (RSRP) greater than the first threshold; or a signal-to-noise and interference ratio (SINR) greater than the first threshold.

Aspect 4 includes the method of any of aspects 1-3, wherein the one or more second reference signals satisfying the second threshold comprises at least one of a reference signal received power (RSRP) greater than the second threshold and less than the first threshold; or a signal-to-noise and interference ratio (SINR) greater than the second threshold and less than the first threshold.

Aspect 5 includes the method of any of aspects 1-4, wherein the transmitting the at least one CSI report comprises transmitting, to the network unit, a single CSI report comprising a first part indicating the one or more first reference signals satisfying the first threshold; and a second part indicating the one or more second reference signals satisfying the second threshold.

Aspect 6 includes the method of any of aspects 1-5, wherein the transmitting the at least one CSI report comprises transmitting, to the network unit, a first CSI report indicating the one or more first reference signals satisfying the first threshold; and transmitting, to the network unit, a second CSI report indicating the one or more second reference signals satisfying the second threshold.

Aspect 7 includes the method of any of aspects 1-6, wherein at least one of the first CSI report includes a CSI report setting ID associated with the second CSI report; or the second CSI report includes a CSI report setting ID associated with the first CSI report.

Aspect 8 includes the method of any of aspects 1-7, wherein the first threshold is based on a first offset from a measurement associated with a reference signal of the first reference signals satisfying the first threshold; and the second threshold is based on a second offset from the first threshold.

Aspect 9 includes the method of any of aspects 1-8, wherein the reference signal of the first reference signals satisfying the first threshold is closest to the first threshold of the first reference signals satisfying the first threshold.

Aspect 10 includes the method of any of aspects 1-9, wherein the CSI report configuration indicates the first threshold and the second threshold.

Aspect 11 includes the method of any of aspects 1-10, wherein the receiving the CSI report configuration comprises receiving the CSI report configuration via at least one of a radio resource control (RRC) message; a semi-persistent activation state configuration via a medium access control control element (MAC-CE); or an aperiodic triggering state configuration downlink control information (DCI).

Aspect 12 includes the method of any of aspects 1-11, wherein the transmitting the at least one CSI report comprises transmitting the at least one CSI report further indicating one or more third reference signals of the plurality of reference signals satisfying a third threshold, wherein the third threshold is based on an offset from the second threshold; the third threshold is different from the first threshold; and the third threshold is different from the second threshold.

Aspect 13 includes the method of any of aspects 1-12, wherein the CSI report configuration includes an indication of a number of the one or more second reference signals satisfying the second threshold to be indicated in the CSI report; and further comprising selecting, based on the number of the one or more second reference signals satisfying the second threshold to be indicated in the CSI report, the one or more second reference signals to indicate in the CSI report from the plurality of reference signals satisfying the second threshold.

Aspect 14 includes the method of any of aspects 1-13, wherein the selecting the one or more second reference signals to indicate in the CSI report comprises selecting the one or more second reference signals to indicate in the CSI report based on at least one of a reference signal received power (RSRP) associated with the plurality of reference signals satisfying the second threshold; or signal-to-noise and interference ratio (SINR) associated with the plurality of reference signals satisfying the second threshold.

Aspect 15 includes the method of any of aspects 1-14, wherein the one or more second reference signals of the plurality of reference signals satisfying the second threshold are associated with a reference signal group; and the transmitting the at least one CSI report comprises transmitting the at least one CSI report further indicating the reference signal group.

Aspect 16 includes the method of any of aspects 1-15, wherein the transmitting the at least one CSI report comprises transmitting, to the network unit at a first periodicity, a first CSI report indicating the one or more first reference signals satisfying the first threshold; and transmitting, to the network unit at a second periodicity, a second CSI report after the first CSI report indicating the one or more second reference signals satisfying the second threshold, wherein the second periodicity is an integer multiple of the first periodicity; and the one or more second reference signals are associated with channel measurement resource identifiers (CMR-IDs) of the one or more first reference signals having a strongest reference signal received power (RSRP).

Aspect 17 includes the method of any of aspects 1-16, wherein the transmitting the at least one CSI report comprises transmitting a first CSI report comprising a CMR-ID associated with the one or more second reference signals satisfying the second threshold; and transmitting a second CSI report after the first CSI report comprising an offset to the CMR-ID associated with the one or more second reference signals satisfying the second threshold.

Aspect 18 includes a method of wireless communication performed by a network unit, the method comprising transmitting, to a user equipment (UE), a channel state information (CSI) report configuration; transmitting, to the UE, a plurality of reference signals; and receiving, from the UE, at least one CSI report based on the CSI report configuration, the at least one CSI report indicating one or more first reference signals of the plurality of reference signals satisfying a first threshold; and one or more second reference signals of the plurality of reference signals satisfying a second threshold, wherein the second threshold is different from the first threshold.

Aspect 19 includes a non-transitory computer-readable medium storing one or more instructions for wireless communication, the one or more instructions comprising one or more instructions that, when executed by one or more processors of a user equipment (UE), cause the UE to perform any one of aspects 1-17.

Aspect 20 includes a non-transitory computer-readable medium storing one or more instructions for wireless communication, the one or more instructions comprising one or more instructions that, when executed by one or more processors of a network unit, cause the network unit to perform aspect 18.

Aspect 21 includes a user equipment (UE) comprising one or more means to perform any one or more of aspects 1-17.

Aspect 22 includes an network unit for wireless communications comprising one or more means to perform aspect 18.

Aspect 23 includes a user equipment (UE) comprising a memory, a transceiver and at least one processor coupled to the memory and the transceiver, wherein the UE is configured to perform any one or more of aspects 1-17.

Aspect 24 includes a network unit comprising a memory, a transceiver and at least one processor coupled to the memory and the transceiver, wherein the network unit is configured to aspect 18.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a user equipment (UE), the method comprising:
receiving, from a network unit, a channel state information (CSI) report configuration;
receiving, from the network unit, a plurality of reference signals; and
transmitting, to the network unit based on the CSI report configuration, at least one CSI report, the at least one CSI report indicating:
one or more first reference signals of the plurality of reference signals satisfying a first threshold; and
one or more second reference signals of the plurality of reference signals satisfying a second threshold, wherein the second threshold is different from the first threshold.

2. The method of claim 1, wherein:
the at least one CSI report indicating the one or more first reference signals satisfying the first threshold comprises a channel measurement resource identifier (CMR-ID) associated with the one or more first reference signals satisfying the first threshold; and
the at least one CSI report indicating the one or more second reference signals satisfying the second threshold comprises a CMR-ID associated with the one or more second reference signals satisfying the second threshold.

3. The method of claim 1, wherein:
the one or more first reference signals satisfying the first threshold comprises at least one of:
a reference signal received power (RSRP) greater than the first threshold; or
a signal-to-noise and interference ratio (SINR) greater than the first threshold; and
the one or more second reference signals satisfying the second threshold comprises at least one of:
a reference signal received power (RSRP) greater than the second threshold and less than the first threshold; or
a signal-to-noise and interference ratio (SINR) greater than the second threshold and less than the first threshold.

4. The method of claim 1, wherein the transmitting the at least one CSI report comprises:
transmitting, to the network unit, a single CSI report comprising:
a first part indicating the one or more first reference signals satisfying the first threshold; and
a second part indicating the one or more second reference signals satisfying the second threshold.

5. The method of claim 1, wherein the transmitting the at least one CSI report comprises:
transmitting, to the network unit, a first CSI report indicating the one or more first reference signals satisfying the first threshold; and
transmitting, to the network unit, a second CSI report indicating the one or more second reference signals satisfying the second threshold.

6. The method of claim 5, wherein at least one of:
the first CSI report includes a CSI report setting ID associated with the second CSI report; or
the second CSI report includes a CSI report setting ID associated with the first CSI report.

7. The method of claim 1, wherein:
the first threshold is based on a first offset from a measurement associated with a reference signal of the first reference signals satisfying the first threshold; and
the second threshold is based on a second offset from the first threshold.

8. The method of claim 1, wherein:
the CSI report configuration indicates the first threshold and the second threshold; and
the receiving the CSI report configuration comprises receiving the CSI report configuration via at least one of:
a radio resource control (RRC) message;
a semi-persistent activation state configuration via a medium access control control element (MAC-CE); or
an aperiodic triggering state configuration downlink control information (DCI).

9. The method of claim 1, wherein the transmitting the at least one CSI report comprises transmitting the at least one CSI report further indicating:
one or more third reference signals of the plurality of reference signals satisfying a third threshold, wherein:
the third threshold is based on an offset from the second threshold;
the third threshold is different from the first threshold; and
the third threshold is different from the second threshold.

10. The method of claim 1, wherein:
the CSI report configuration includes an indication of a number of the one or more second reference signals satisfying the second threshold to be indicated in the CSI report; and
further comprising:
selecting, based on the number of the one or more second reference signals satisfying the second threshold to be indicated in the CSI report, the one or more second reference signals to indicate in the CSI report from the plurality of reference signals satisfying the second threshold.

11. The method of claim 10, wherein the selecting the one or more second reference signals to indicate in the CSI report comprises selecting the one or more second reference signals to indicate in the CSI report based on at least one of:
a reference signal received power (RSRP) associated with the plurality of reference signals satisfying the second threshold; or
signal-to-noise and interference ratio (SINR) associated with the plurality of reference signals satisfying the second threshold.

12. The method of claim 1, wherein:
the one or more second reference signals of the plurality of reference signals satisfying the second threshold are associated with a reference signal group; and
the transmitting the at least one CSI report comprises transmitting the at least one CSI report further indicating the reference signal group.

13. The method of claim 1, wherein the transmitting the at least one CSI report comprises:
transmitting, to the network unit at a first periodicity, a first CSI report indicating the one or more first reference signals satisfying the first threshold; and
transmitting, to the network unit at a second periodicity, a second CSI report after the first CSI report indicating the one or more second reference signals satisfying the second threshold, wherein:
the second periodicity is an integer multiple of the first periodicity; and
the one or more second reference signals are associated with channel measurement resource identifiers (CMR-IDs) of the one or more first reference signals having a strongest reference signal received power (RSRP).

14. The method of claim 1, wherein the transmitting the at least one CSI report comprises:
transmitting a first CSI report comprising a CMR-ID associated with the one or more second reference signals satisfying the second threshold; and
transmitting a second CSI report after the first CSI report comprising an offset to the CMR-ID associated with the one or more second reference signals satisfying the second threshold.

15. A method of wireless communication performed by a network unit, the method comprising:
transmitting, to a user equipment (UE), a channel state information (CSI) report configuration;
transmitting, to the UE, a plurality of reference signals; and
receiving, from the UE, at least one CSI report based on the CSI report configuration, the at least one CSI report indicating:
one or more first reference signals of the plurality of reference signals satisfying a first threshold; and
one or more second reference signals of the plurality of reference signals satisfying a second threshold, wherein the second threshold is different from the first threshold.

16. A user equipment (UE) comprising:
a memory;
a transceiver; and
at least one processor coupled to the memory and the transceiver, wherein the UE is configured to:
receive, from a network unit, a channel state information (CSI) report configuration;
receive, from the network unit, a plurality of reference signals; and
transmit, to the network unit based on the CSI report configuration, at least one CSI report, the at least one CSI report indicating:
one or more first reference signals of the plurality of reference signals satisfying a first threshold; and
one or more second reference signals of the plurality of reference signals satisfying a second threshold, wherein the second threshold is different from the first threshold.

17. The UE of claim 16, wherein:
the at least one CSI report indicating the one or more first reference signals satisfying the first threshold comprises a channel measurement resource identifier (CMR-ID) associated with the one or more first reference signals satisfying the first threshold; and
the at least one CSI report indicating the one or more second reference signals satisfying the second threshold comprises a CMR-ID associated with the one or more second reference signals satisfying the second threshold.

18. The UE of claim 16, wherein:
the one or more first reference signals satisfying the first threshold comprises at least one of:
a reference signal received power (RSRP) greater than the first threshold; or
a signal-to-noise and interference ratio (SINR) greater than the first threshold; and
the one or more second reference signals satisfying the second threshold comprises at least one of:
a reference signal received power (RSRP) greater than the second threshold and less than the first threshold; or
a signal-to-noise and interference ratio (SINR) greater than the second threshold and less than the first threshold.

19. The UE of claim 16, wherein the UE is further configured to:
transmit, to the network unit, a single CSI report comprising:
a first part indicating the one or more first reference signals satisfying the first threshold; and
a second part indicating the one or more second reference signals satisfying the second threshold.

20. The UE of claim 16, wherein the UE is further configured to:
transmit, to the network unit, a first CSI report indicating the one or more first reference signals satisfying the first threshold; and
transmit, to the network unit, a second CSI report indicating the one or more second reference signals satisfying the second threshold.

21. The UE of claim 20, wherein at least one of:
the first CSI report includes a CSI report setting ID associated with the second CSI report; or
the second CSI report includes a CSI report setting ID associated with the first CSI report.

22. The UE of claim 16, wherein:
the first threshold is based on a first offset from a measurement associated with a reference signal of the first reference signals satisfying the first threshold; and
the second threshold is based on a second offset from the first threshold.

23. The UE of claim 16, wherein:
the CSI report configuration indicates the first threshold and the second threshold; and
the UE is further configured to:
receive the CSI report configuration via at least one of:
a radio resource control (RRC) message;
a semi-persistent activation state configuration via a medium access control control element (MAC-CE); or
an aperiodic triggering state configuration downlink control information (DCI).

24. The UE of claim 16, wherein the UE is further configured to:
transmit the at least one CSI report further indicating:
one or more third reference signals of the plurality of reference signals satisfying a third threshold, wherein:
the third threshold is based on an offset from the second threshold;
the third threshold is different from the first threshold; and
the third threshold is different from the second threshold.

25. The UE of claim 16, wherein:
the CSI report configuration includes an indication of a number of the one or more second reference signals satisfying the second threshold to be indicated in the CSI report; and
wherein the UE is further configured to:
select, based on the number of the one or more second reference signals satisfying the second threshold to be indicated in the CSI report, the one or more second reference signals to indicate in the CSI report from the plurality of reference signals satisfying the second threshold.

26. The UE of claim 25, wherein the UE is further configured to:
select the one or more second reference signals to indicate in the CSI report based on at least one of:
a reference signal received power (RSRP) associated with the plurality of reference signals satisfying the second threshold; or
signal-to-noise and interference ratio (SINR) associated with the plurality of reference signals satisfying the second threshold.

27. The UE of claim 16, wherein:
the one or more second reference signals of the plurality of reference signals satisfying the second threshold are associated with a reference signal group; and
the UE is further configured to:
transmit the at least one CSI report further indicating the reference signal group.

28. The UE of claim 16, wherein the UE is further configured to:
transmit, to the network unit at a first periodicity, a first CSI report indicating the one or more first reference signals satisfying the first threshold; and
transmit, to the network unit at a second periodicity, a second CSI report after the first CSI report indicating the one or more second reference signals satisfying the second threshold, wherein:
the second periodicity is an integer multiple of the first periodicity; and
the one or more second reference signals are associated with channel measurement resource identifiers (CMR-IDs) of the one or more first reference signals having a strongest reference signal received power (RSRP).

29. The UE of claim 16, wherein the UE is further configured to:
transmit a first CSI report comprising a CMR-ID associated with the one or more second reference signals satisfying the second threshold; and
transmit a second CSI report after the first CSI report comprising an offset to the CMR-ID associated with the one or more second reference signals satisfying the second threshold.

30. A network unit comprising:
a memory;
a transceiver; and
at least one processor coupled to the memory and the transceiver, wherein the network unit is configured to:
transmit, to a user equipment (UE), a channel state information (CSI) report configuration;
transmit, to the UE, a plurality of reference signals; and
receive, from the UE, at least one CSI report based on the CSI report configuration, the at least one CSI report indicating:
one or more first reference signals of the plurality of reference signals satisfying a first threshold; and
one or more second reference signals of the plurality of reference signals satisfying a second threshold, wherein the second threshold is different from the first threshold.
